(19) United States
(12) Patent Application Publication
(10) Pub. No.: US 2025/0149217 A1
(43) Pub. Date: May 8, 2025

(54) COIL ELECTRONIC COMPONENT AND MANUFACTURING METHOD THEREOF

(71) Applicant: SAMSUNG ELECTRO-MECHANICS CO., LTD., Suwon-si (KR)

(72) Inventors: Byeongcheol Moon, Suwon-si (KR); Tae Hyun Kim, Suwon-si (KR)

(73) Assignee: SAMSUNG ELECTRO-MECHANICS CO., LTD., Suwon-si (KR)

(21) Appl. No.: 18/909,609

(22) Filed: Oct. 8, 2024

(30) Foreign Application Priority Data
Nov. 7, 2023 (KR) 10-2023-0152742
Mar. 6, 2024 (KR) 10-2024-0032098

(51) Int. Cl. H01F 5/04; H01F 3/08; H01F 27/02; H01F 41/00; H01F 41/02

(52) U.S. Cl. CPC H01F 5/04; H01F 27/022; H01F 41/005; H01F 41/0246; H01F 3/08

(57) ABSTRACT

A coil electronic component may include a magnetic body having a first surface and a second surface opposing each other in a first direction, a third surface and a fourth surface opposing each other in a second direction intersecting the first direction, and a fifth surface and a sixth surface opposing each other in a third direction intersecting both the first and second directions and including a magnetic material, a coil embedded in the magnetic body, an external electrode disposed on the sixth surface of the magnetic body, and at least one connection electrode disposed within the magnetic body and connecting the coil and the external electrode and including an extension portion having a diameter greater than a diameter of a remaining portion of the connection electrode.

### CROSS-REFERENCE TO RELATED APPLICATION

This application claims priority to and the benefit of Korean Patent Application No. 10-2024-0032098 filed in the Korean Intellectual Property Office on Mar. 6, 2024, and Korean Patent Application No. 10-2023-0152742 filed in the Korean Intellectual Property Office on Nov. 7, 2023, the entire contents of which are incorporated herein by reference.

### TECHNICAL FIELD

The present disclosure relates to a coil electronic component.

### BACKGROUND

Recently, as the functions of mobile devices diversify, power consumption increases, and in order to increase battery usage time in mobile devices, coil electronic components with low loss and excellent efficiency are employed around a power management integrated circuit (PMIC).

On the other hand, there is a growing demand for a thin power inductor in order to slim products and increase the degree of freedom in component arrangement. In particular, the demand for thin-film power inductors with external electrodes placed only on the surface to be mounted on the substrate is increasing.

### SUMMARY

In one aspect, the present disclosure attempts to provide a coil electronic component having a thin thickness.

In another aspect, the present disclosure attempts to provide a manufacturing method of a coil electronic component having a thin thickness.

However, the objective of the present disclosure is not limited to the aforementioned one, and may be extended in various ways within the spirit and scope of the present disclosure.

A coil electronic component may include a magnetic body having a first surface and a second surface opposing each other in a first direction, a third surface and a fourth surface opposing each other in a second direction intersecting the first direction, and a fifth surface and a sixth surface opposing each other in a third direction intersecting both the first and second directions and including a magnetic material, a coil embedded in the magnetic body, an external electrode disposed on the sixth surface of the magnetic body, and at least one connection electrode disposed within the magnetic body and connecting the coil and the external electrode and including an extension portion having a diameter greater than a diameter of a remaining portion of the connection electrode.

The coil electronic component further includes a support member embedded in the magnetic body and including a first support surface and a second support surface opposing each other in the third direction, and the coil includes a first coil pattern disposed on the first support surface of the support member, a second coil pattern disposed on the second support surface of the support member, and a via connecting the first coil pattern and the second coil pattern.

The extension portion may be disposed at an end portion of the connection electrode that is connected to the coil.

The connection electrode may include a first portion extending in the third direction and connected to the coil and a second portion extending in the first direction and connected to the external electrode.

The connection electrode may include a first portion extending in the third direction and connected to the coil and a second portion extending in the second direction and connected to the external electrode.

The connection electrode may be formed of a different material from the coil, and an intermetallic compound may be disposed at an interface between the connection electrode and the coil.

The coil may include copper (Cu), and the connection electrode may include gold (Au), aluminum (Al), silver (Ag), or an alloy thereof.

A portion where the connection electrode is connected to the external electrode and a portion where the connection electrode is connected to the coil may be on a center line in the first direction when viewed from the third direction.

A portion where the connection electrode is connected to the external electrode and a portion where the connection electrode is connected to the coil may be biased toward the second direction with respect to a center line in the first direction when viewed from the third direction.

The external electrode may include a first external electrode and a second external electrode, the connection electrode may include a first connection electrode connecting the first coil pattern and the first external electrode and a second connection electrode connecting the second coil pattern and the second external electrode, and the first connection electrode and the second connection electrode may be disposed to be biased toward the third surface or the fourth surface of the magnetic body.

The external electrode may include a first external electrode and a second external electrode, the connection electrode may include a first connection electrode connecting the first coil pattern and the first external electrode and a second connection electrode connecting the second coil pattern and the second external electrode, and one connection electrode among the first connection electrode and the second connection electrode may be disposed to be biased toward the third surface of the magnetic body, and the other connection electrode may be disposed to be biased toward the fourth surface.

A method of manufacturing a coil electronic component may include preparing a plurality of coils, connecting pairs of adjacent coils of the plurality of coils to each other by connection conductors, disposing the plurality of coils on a first magnetic body, applying a magnetic material to cover the plurality of coils, forming a second magnetic body by pressing and curing the magnetic material, forming an individual laminate by dicing the first magnetic body and the second magnetic body such that each connection conductor may be divided into a first connection electrode and a second connection electrode, and forming a first external electrode that is connected to the first connection electrode of the individual laminate and a second external electrode that is connected to the second connection electrode of the individual laminate.

The step of preparing a plurality of coils may include preparing a support member having the plurality of coils, each surrounding a corresponding through-hole, where each coil may include a first coil pattern disposed on a first surface of the support member, and a second coil pattern disposed on a second surface of the support member opposing the first surface and connected to the first coil pattern by a via penetrating the support member.

The step of connecting pairs of adjacent coils of the plurality of coils may include connecting pairs of adjacent first coil patterns of the plurality of coils to each other by the connection conductors.

The step of disposing the plurality of coils on a first magnetic body may include disposing the support member on a first magnetic body.

The step of applying a magnetic material to cover the plurality of coils may include applying a magnetic material to cover the support member.

The step of forming an individual laminate may include dicing the support member.

In the step of applying the magnetic material, a portion of the connection conductor may be exposed.

The method of manufacturing a coil electronic component may further include, before the step of forming the individual laminate, forming a first insulation layer on an outer surface of the first magnetic body, and forming a second insulation layer on an outer surface of the second magnetic body.

In the step of forming of the second insulation layer on an outer surface of the second magnetic body, the second insulation layer may be formed to be spaced apart from the exposed portion of the connection conductor.

The method of manufacturing a coil electronic component may include, before the step of forming the first external electrode and the second external electrode, forming a third insulation layer on an end surface of the individual laminate in a direction along which the support member is diced.

The method of manufacturing a coil electronic component may include, before the step of forming the individual laminate, forming a second insulation layer on an outer surface of the second magnetic body, and forming an adhesive layer to cover the second insulation layer and an outer surface of the second magnetic body.

The method of manufacturing a coil electronic component may include, before the step of forming the first external electrode and the second external electrode, forming a fourth insulation layer to cover the adhesive layer and an outer surface of the individual laminate, and removing the adhesive layer.

A method of manufacturing a coil electronic component may include preparing a plurality of coils, connecting two connection electrodes to each of the plurality of coils, disposing the plurality of coils on a first magnetic body, applying a magnetic material to cover the plurality of coils, forming a second magnetic body by pressing and curing the magnetic material, forming an individual laminate by dicing the first magnetic body and the second magnetic body, and forming an external electrode that is connected to a connection electrode of the individual laminate

The step of preparing a plurality of coils may include preparing a support member having a plurality of coils, each surrounding a corresponding through-hole and comprising a first coil pattern disposed on a first surface of the support member with respect to the through-hole, and a second coil pattern disposed on a second surface of the support member and connected to the first coil pattern by a via penetrating the support member, the first and second surfaces opposing each other.

The step of connecting two connection electrodes may include connecting two connection electrodes to each first coil pattern.

The step of disposing the plurality of coils on a first magnetic body may include disposing the support member on a first magnetic body.

The step of applying a magnetic material to cover the plurality of coils may include applying a magnetic material to cover the support member

The step of forming an individual laminate may include dicing the support member.

A coil electronic component may include a magnetic body encapsulating a coil; an external electrode disposed on an external surface of the magnetic body; and a connection electrode disposed in the magnetic body and connecting the coil to the external electrode, the connection electrode comprising a wire. A cross-section of the wire at a first end of the wire contacts the coil, and one or both of a cross-section and a surface area of the wire at a second end of the wire contacts the external electrode.

The coil electronic component may further include a support member having a through-hole penetrating therethrough and the coil may include a first coil pattern disposed on a first surface of the support member and around the through-hole; a second coil pattern disposed on a second surface of the support member opposing the first surface in a direction and around the through-hole.

The magnetic body may encapsulate the support member and the first and second coil patterns, a portion of the magnetic body filling the through-hole to form a core of the first and second coil patterns. The external electrode may include first and second external electrodes disposed on an external surface of the magnetic body and spaced apart from each other. The connection electrode may include first and second connection electrode disposed in the magnetic body and respectively connecting the first and second coil patterns to the first and second external electrodes, each of the first and second connection electrodes comprising a wire. A cross-section of the wire at a first end of the wire contacts a corresponding coil pattern, and one or both of a cross-section and a surface area of the wire at a second end of the wire contacts a corresponding external electrode.

One or both of the first and second coil patterns may include a lead-out portion, to which the first end of the wire is connected.

One or both of the first and second connection electrodes may include a plurality of wires, each connected to the corresponding coil pattern and the corresponding external electrode.

The coil electronic component may further include an insulation layer disposed on an external surface of the magnetic body except at a portion where the first and second external electrodes are disposed.

A material of the wire may be different from a material of the first and second coil patterns.

A contact between the wire and the corresponding connection electrode may include an intermetallic compound.

When viewed in the direction along which the first and second surfaces of the support member oppose each other, the second end of the wire of one or both the first and second connection electrodes may not overlap with the corresponding coil pattern.

A surface each of the first and second coil patterns may be covered by an insulating film except for a portion where the wire contacts the corresponding coil pattern.

The portion where the wire contacts the corresponding coil pattern may have an area larger than a cross-section area of the wire.

According to an embodiment, a coil electronic component having a thin thickness may be provided.

In addition, according to an embodiment, a manufacturing method of a coil electronic component having a thin thickness may be provided.

### BRIEF DESCRIPTION OF THE DRAWINGS

FIG. 1 is a perspective view schematically showing a coil electronic component according to an embodiment.

FIG. 2 is a schematic cross-sectional view taken along line II-II′ of FIG. 1.

FIG. 3 is a schematic cross-sectional view taken along line III-III′ of FIG. 1.

FIG. 4 is a bottom view schematically showing the coil electronic component of FIG. 1.

FIG. 5 is a drawing schematically showing a first coil pattern and a second coil pattern of a coil electronic component according to a modified example.

FIG. 6 is a drawing schematically showing a first coil pattern and a second coil pattern of a coil electronic component according to another modified example.

FIG. 7 is a drawing schematically showing a first coil pattern and a second coil pattern of a coil electronic component according to still another modified example.

FIG. 8 is a drawing schematically showing a first coil pattern and a second coil pattern of a coil electronic component according to another modified example.

FIG. 9 is a drawing schematically showing a first coil pattern and a second coil pattern of a coil electronic component according to still another modified example.

FIG. 10 is a drawing schematically showing a first coil pattern and a second coil pattern of a coil electronic component according to still another modified example.

FIG. 11 is a drawing schematically showing a first coil pattern and a second coil pattern of a coil electronic component according to still another modified example.

FIG. 12 is a drawing schematically showing a first coil pattern and a second coil pattern of a coil electronic component according to still another modified example.

FIG. 13 is a drawing schematically showing a first coil pattern and a second coil pattern of a coil electronic component according to still another modified example.

FIG. 14 is a perspective view schematically showing a coil electronic component according to another embodiment.

FIG. 15 is a schematic cross-sectional view taken along line XV-XV′ of FIG. 14.

FIG. 16 is a schematic cross-sectional view taken along line XVI-XVI′ of FIG. 14.

FIG. 17 is a bottom view schematically showing the coil electronic component of FIG. 14.

FIG. 18 is a perspective view schematically showing a coil electronic component according to still another embodiment.

FIG. 19 is a schematic cross-sectional view taken along line XIX-XIX′ of FIG. 18.

FIG. 20 is a bottom view schematically showing the coil electronic component of FIG. 18.

FIG. 21 is a flowchart showing a manufacturing method of a coil electronic component according to an embodiment.

FIG. 22A to FIG. 22G are drawings sequentially showing a manufacturing method of a coil electronic component according to an embodiment.

FIG. 23 is a flowchart showing a manufacturing method of a coil electronic component according to another embodiment.

FIG. 24A to FIG. 24D are drawings sequentially showing a manufacturing method of a coil electronic component by using a ball bonding wire.

FIG. 25A to FIG. 25C are drawings sequentially showing a manufacturing method of a coil electronic component by using a wedge wire bonding.

FIG. 26 is a flowchart showing a manufacturing method of a coil electronic component according to another embodiment.

FIG. 27A to FIG. 27I are drawings sequentially showing a manufacturing method of a coil electronic component according to another embodiment.

FIG. 28 is a flowchart showing a manufacturing method of a coil electronic component according to still another embodiment.

FIG. 29A and FIG. 29B are drawings for explaining a manufacturing method of a coil electronic component.

FIG. 30 is a drawing schematically showing two coil electronic components according to an embodiment in a state of being connected in parallel.

FIG. 31 is a drawing schematically showing two coil electronic components according to another embodiment in a state of being connected in parallel.

FIG. 32 is a drawing schematically showing two coil electronic components according to still another embodiment in a state of being connected in parallel.

### DETAILED DESCRIPTION

The present disclosure will be described more fully hereinafter with reference to the accompanying drawings, in which embodiments of the disclosure are shown. The drawings and description are to be regarded as illustrative in nature and not restrictive. Like reference numerals designate like elements throughout the specification. In addition, some constituent elements are exaggerated, omitted, or briefly illustrated in the added drawings, and sizes of the respective constituent elements do not reflect the actual sizes.

The accompanying drawings are provided only in order to allow embodiments disclosed in the present specification to be easily understood and are not to be interpreted as limiting the spirit disclosed in the present specification, and it is to be understood that the present disclosure includes all modifications, equivalents, and substitutions without departing from the scope and spirit of the present disclosure.

Terms including ordinal numbers such as first, second, and the like will be used only to describe various constituent elements, and are not to be interpreted as limiting these constituent elements. The terms are only used to differentiate one constituent element from other constituent elements.

It will be understood that when an element such as a layer, film, region, area, or substrate is referred to as being “on” or “above” another element, it can be directly on the other element or intervening elements may also be present. In contrast, when an element is referred to as being “directly on” another element, there are no intervening elements present. Further, in the specification, the word “on” or “above” means disposed on or below the object portion, and does not necessarily mean disposed on the upper side of the object portion based on a gravitational direction.

Throughout the specification, it should be understood that the term “include”, “comprise”, “have”, or “configure” indicates that a feature, a number, a step, an operation, a constituent element, a part, or a combination thereof described in the specification is present, but does not exclude a possibility of presence or addition of one or more other features, numbers, steps, operations, constituent elements, parts, or combinations, in advance. Unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Furthermore, throughout the specification, “connected” does not only mean when two or more elements are directly connected, but also when two or more elements are indirectly connected through other elements, and when they are physically connected or electrically connected, and further, it may be referred to by different names depending on a position or function, and may also be referred to as a case in which respective parts that are substantially integrated are linked to each other.

As used herein, the term “about” is relative to the actual value stated, as will be appreciated by those of skill in the art, and allows for approximations, inaccuracies and limits of measurement under the relevant circumstances. In one or more aspects, the terms “about,” “substantially,” and “approximately” may provide an industry-accepted tolerance for their corresponding terms and/or relativity between items, such as a tolerance of from less than one percent to ten percent of the actual value stated, and other suitable tolerances.

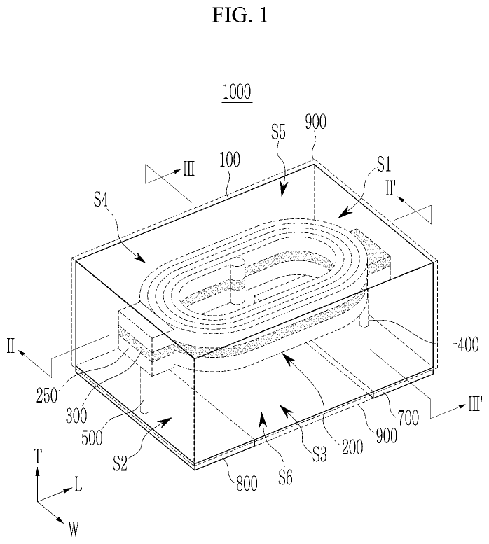

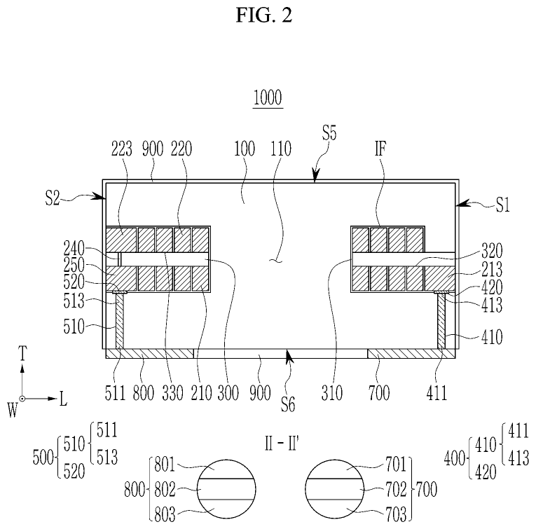

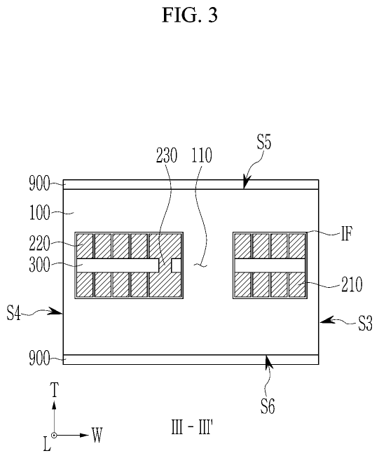

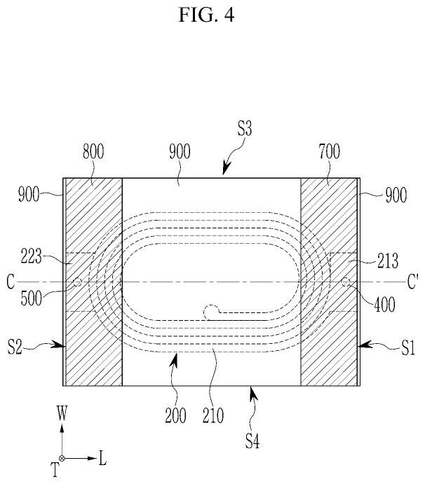

FIG. 1 is a perspective view schematically showing a coil electronic component according to an embodiment. FIG. 2 is a schematic cross-sectional view taken along line II-II′ of FIG. 1. FIG. 3 is a schematic cross-sectional view taken along line III-III′ of FIG. 1. FIG. 4 is a bottom view schematically showing the coil electronic component of FIG. 1.

Referring to FIG. 1, FIG. 2, FIG. 3, and FIG. 4, a coil electronic component 1000 according to an embodiment may include a magnetic body 100, a coil 200, a support member 300, a first connection electrode 400, a second connection electrode 500, a first external electrode 700, a second external electrode 800, and a surface insulation layer 900.

The magnetic body 100 may have a substantially rectangular parallelepiped shape, but the present embodiment is not limited thereto. Due to contraction during sintering, the magnetic body 100 may have a substantially rectangular parallelepiped shape, although not a perfect rectangular parallelepiped shape. For example, the magnetic body 100 has a substantially rectangular parallelepiped shape, but corner or vertex portions may have a round shape.

In the present embodiment, for convenience of description, two surfaces facing each other in a length direction (L-axis direction) are defined as a first surface S1 and a second surface S2, respectively, two surfaces facing each other in a width direction (W-axis direction) are defined as a third surface S3 and a fourth surface S4, respectively, and two surfaces facing each other in a thickness direction (T-axis direction) are defined as a fifth surface S5 and a sixth surface S6, respectively.

A length of the coil electronic component 1000 may mean, based on an optical microscope or scanning electron microscope (SEM) photograph of a cross-section in the length direction (the L-axis direction)—the thickness direction (the T-axis direction) at a center of the coil electronic component 1000 in the width direction (the W-axis direction), a maximum value of lengths of a plurality of line segments that connect two outermost boundary lines facing each other in the length direction (the L-axis direction) of the coil electronic component 1000 shown in the above cross-sectional photograph and are parallel to the length direction (the L-axis direction). Alternatively, the length of the coil electronic component 1000 may mean a minimum value of lengths of a plurality of line segments that connect two outermost boundary lines facing each other in the length direction (the L-axis direction) of the coil electronic component 1000 shown in the above-mentioned cross-section photograph and are parallel to the length direction (the L-axis direction), respectively. Alternatively, the length of the coil electronic component 1000 may mean an arithmetic average value of lengths of at least two of a plurality of line segments that connect two outermost boundary lines facing each other in the length direction (the L-axis direction) of the coil electronic component 1000 shown in the above cross-sectional photograph and are parallel to the length direction (the L-axis direction).

A thickness of the coil electronic component 1000 may mean, based on an optical microscope or scanning electron microscope (SEM) photograph of a cross-section in the length direction (the L-axis direction)—the thickness direction (the T-axis direction) at a center of the coil electronic component 1000 in the width direction (the W-axis direction), a maximum value of lengths of a plurality of line segments that connect two outermost boundary lines facing each other in the thickness direction (the T-axis direction) of the coil electronic component 1000 shown in the above cross-sectional photograph and are parallel to the thickness direction (the T-axis direction). Alternatively, the thickness of the coil electronic component 1000 may mean a minimum value of lengths of a plurality of line segments that connect two outermost boundary lines facing each other in the thickness direction (the T-axis direction) of the coil electronic component 1000 shown in the above-mentioned cross-section photograph and are parallel to the thickness direction (the T-axis direction), respectively. Alternatively, the thickness of the coil electronic component 1000 may mean an arithmetic average value of lengths of at least two line segments among a plurality of line segments that connect two outermost boundary lines facing each other in the thickness direction (the T-axis direction) of the coil electronic component 1000 shown in the above-mentioned cross-section photograph and parallel to the thickness direction (the T-axis direction), respectively.

A width of the coil electronic component 1000 may mean, based on an optical microscope or scanning electron microscope (SEM) photograph of a cross-section in the length direction (the L-axis direction)—the width direction (the W-axis direction) at a center of the coil electronic component 1000 in the thickness direction (the T-axis direction), a maximum value of lengths of a plurality of line segments that connect two outermost boundary lines facing each other in the width direction (the W-axis direction) of the coil electronic component 1000 shown in the above cross-sectional photograph and are parallel to the width direction (the W-axis direction). Alternatively, the width of the coil electronic component 1000 may mean a minimum value of lengths a plurality of line segments that connect two outermost boundary lines facing each other in the width direction (the W-axis direction) of the coil electronic component 1000 shown in the above-mentioned cross-section photograph and are parallel to the width direction (the W-axis direction), respectively. On the other hand, the width of the coil electronic component 1000 may mean an arithmetic average value of lengths of at least two line segments among a plurality of line segments that connect two outermost boundary lines facing each other in the width direction (the W-axis direction) of the coil electronic component 1000 shown in the above-mentioned cross-section photograph and are parallel to the width direction (the W-axis direction), respectively.

Each of the length, width, and the thickness of the coil electronic component 1000 may be measured using a micrometer measurement method. In the micrometer measurement method, a zero point is set with a micrometer providing repeatability and reproducibility (Gage R & R), the coil electronic component 1000 according to the present embodiment is inserted between tips of the micrometer, and a measuring lever of the micrometer is turned for the measurement. When measuring the length of the coil electronic component 1000 by the micrometer measurement method, the length of the coil electronic component 1000 may mean a value measured once or mean an arithmetic average of values measured a plurality of times. This may be equally applied to measuring the width and the thickness of the coil electronic component 1000.

The magnetic body 100 constitutes an exterior of the coil electronic component 1000, and is a space where a magnetic path, which is a path through which the magnetic flux generated by the coil 200 passes, is formed, when a current is applied to the coil 200 through the first external electrode 700 and the second external electrode 800.

The magnetic body 100 surrounds and encapsulates the coil 200 and the support member 300, and includes a magnetic material. The magnetic body 100 includes magnetic particles, and an insulation material may be interposed between the magnetic particles.

The magnetic material may include a first metal magnetic powder, a second metal magnetic powder having a smaller particle size than the first magnetic powder, and a third metal magnetic powder having a smaller particle size than the second magnetic powder. An average particle diameter D₅₀ of the first metal magnetic powder may be in a range from about 5 μm to about 30 μm, an average particle diameter D₅₀ of the second metal magnetic powder may be in a range from about 1 μm to about 5 μm, and an average particle diameter D₅₀ of the third metal magnetic powder may be in a range from about 0.05 μm to about 0.5 μm.

The magnetic particles may be ferrite particles or metal magnetic particles exhibiting magnetic properties.

The ferrite particles may include, for example, at least one of spinel-type ferrites such as Mg—Zn-based, Mn—Zn-based, Mn—Mg-based, Cu—Zn-based, Mg—Mn—Sr-based, Ni—Zn-based ferrites, hexagonal ferrites such as Ba—Zn-based, Ba—Mg-based, Ba—Ni-based, Ba—Co-based, Ba—Ni—Co-based ferrites, garnet-type ferrites such as Y-based ferrites and Li-based ferrite.

The metal magnetic particles may be composed of two or more types of powders having different compositions, and may include at least one selected from the group consisting of iron (Fe), silicon (Si), chromium (Cr), cobalt (Co), molybdenum (Mo), aluminum (Al), niobium (Nb), copper (Cu), and nickel (Ni). For example, metal magnetic particles may be at least one of pure iron, Fe—Si-based alloy, Fe—Si—Al-based alloy, Fe—Ni-based alloy, Fe—Ni—Mo-based alloy, Fe—Ni—Mo—Cu-based alloy, Fe—Co-based alloy, Fe—Ni—Co-based alloy, Fe—Cr-based alloy, Fe—Cr—Si-based alloy, Fe—Si—Cu—Nb-based alloy, Fe—Ni—Cr-based alloy, Fe—Cr—Al-based alloy. Here, different compositions of the metal magnetic particles may mean different contents.

The metal magnetic particles may be amorphous or crystalline. For example, the metal magnetic particles may be an Fe—Si—B—Cr-based amorphous alloy, but the present embodiment is not limited thereto. The metal magnetic particles may have an average diameter in a range from about 0.1 μm to about 30 μm, but are not limited thereto.

In the present specification, the particle diameter or average diameter may mean a particle size distribution expressed by D₉₀, D₅₀, or the like. The particle size distribution is well known to those skilled in the art as an index indicating what size (particle size) particles are included in what proportion in a particle group to be measured. D₅₀ (a particle size corresponding to 50% of a cumulative volume of the particle size distribution) refers to an average particle diameter.

The metal magnetic particles may be two or more types of different metal magnetic particles. Here, by different types of metal magnetic particles, it is meant that the metal magnetic particles are distinguished from each other in at least one of average particle size, composition, component ratio, crystallinity, and shape.

The insulating resin may include epoxy, polyimide, liquid crystal polymer, etc. alone or in combination, but is not limited thereto.

A method of forming the magnetic body 100 is not particularly limited. For example, the magnetic body 100 may be formed by placing sheets of magnetic material on the upper and lower portions of the coil 200 and then compressing and curing the sheets.

The support member 300 is disposed inside the magnetic body 100 and supports the coil 200.

The support member 300 may be formed of an insulation material including a thermosetting insulating resin such as epoxy resin, a thermoplastic insulating resin such as polyimide, or a photosensitive insulating resin, or may be formed of an insulation material formed by impregnating a reinforcing material such as glass fiber or inorganic filler in the insulating resin. For example, the support member 300 may be formed of an insulation material such as prepreg, ABF (Ajinomoto Build-up Film), FR-4, BT (Bismaleimide Triazine) film, PID (Photo Imagable Dielectric) film, or the like, but the present embodiment is not limited thereto.

At least one selected from a group consisting of silica (SiO₂), alumina (Al₂O₃), silicon carbide (SiC), barium sulfate (BaSO₄), Talc, mud, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃) and calcium zirconate (CaZrO₃) may be used as the inorganic filler.

A through-hole 310 is at a center of the support member 300. The through-hole 310 forms a core 110 by being filled with the magnetic material forming the magnetic body 100, and may improve the performance of the coil electronic component.

The coil 200 is embedded in the magnetic body 100 to exhibit the characteristics of the coil electronic component 1000. For example, when the coil electronic component 1000 of the present embodiment is used as a power inductor, when current is applied to the coil 200, the coil 200 may serve to stabilize the power of an electronic device by storing an electric field in the form of a magnetic field to maintain an output voltage.

The coil 200 may be disposed on a first support surface 320 and a second support surface 330 of the support member 300 which are opposing each other. The coil 200 may include a first coil pattern 210 and a second coil pattern 220, which may be electrically connected to each other through a first via 230.

The first coil pattern 210 is disposed on the first support surface 320 of the support member 300 and includes a first lead-out portion 213. The first lead-out portion 213 may be electrically connected to the first external electrode 700 by the first connection electrode 400. The first coil pattern 210 may not be directly physically connected to a connection portion 250. For example, the first coil pattern 210 and the connection portion 250 may be formed of the same conductive metal, but may be spaced apart from each other.

The second coil pattern 220 is disposed on the second support surface 330 of the support member 300 and includes a second lead-out portion 223. The second lead-out portion 223 may be electrically connected to the second external electrode 800 by a second via 240, the connection portion 250, and the second connection electrode 500.

When the first coil pattern 210, the first lead-out portion 213, the first via 230, the second via 240 and the connection portion 250 are formed by plating on the first support surface 320 of the support member 300, the first coil pattern 210, the first lead-out portion 213, the first via 230, the second via 240 and the connection portion 250 may respectively include a seed layer such as an electroless plating layer and an electroplating layer. Here, the electroplating layer may have a single-layer structure or a multi-layer structure. The electroplating layer of the multi-layer structure may be formed in a conformal film structure in which a first electroplating layer is covered by a second electroplating layer, or in the shape of stack in which a second electroplating layer is stacked on only one surface of first electroplating layer. A seed layer of the first coil pattern 210, a seed layer of the first lead-out portion 213, a seed layer of the first via 230, a seed layer of the second via 240 and a seed layer of the connection portion 250 may be formed at the same time in a same process step. An electroplating layer of the first coil pattern 210, an electroplating layer of the first lead-out portion 213, an electroplating layer of the first via 230, an electroplating layer of the second via 240 and an electroplating layer of the connection portion 250 may be formed in a same process step, but the present embodiment may not be limited thereto. The above description may be equally applied to the second coil pattern 220, the second lead-out portion 223, the first via 230 and the second via 240.

Each of the coil 200 and the via 230 and 240 may be formed of a conductive material such as, copper (Cu), aluminum (Al), silver (Ag), tin (Sn), gold (Au), nickel (Ni), lead (Pb), titanium (Ti), an alloy thereof, or the like, but the present embodiment is not limited thereto.

An insulation layer IF may be disposed between the coil 200 and the magnetic body 100. The insulation layer IF may be formed along a surface of the support member 300 and the coil 200. The insulation layer IF does not exist in a portion where the support member 300 and the coil 200 are connected to the connection electrodes 400 and 500. The insulation layer IF is for insulating the coil 200 from the magnetic body 100 and may include a known insulating material such as parylene. Any insulating material may be used in the insulation layer IF, and there is no particular limitation. For example, the insulation layer IF may be a polyurethane resin, a polyester resin, an epoxy resin, or a polyamideimide resin. The insulation layer IF may be formed by a method such as vapor deposition, but is not limited thereto. For example, the insulation layer IF may be formed by stacking insulating films on both surfaces of the support member 300.

The first connection electrode 400 may electrically connect the coil 200 to the first external electrode 700 within the magnetic body 100, and the second connection electrode 500 may electrically connect the coil 200 to the second external electrode 800 within the magnetic body 100.

The first connection electrode 400 may be disposed within the magnetic body 100. For example, the first connection electrode 400 may be spaced apart from the first surface S1, the third surface S3 and the fourth surface S4 of the magnetic body 100.

The first connection electrode 400 may be a conductive wire. The conductive wire may be, for example, a bonding wire. That is, the first connection electrode 400 may be connected to the first lead-out portion 213 of the first coil pattern 210 by ball bonding. The connection method by ball bonding may be as commonly known in the art. For example, the ball bonding may be performed by melting a frontal end of the bonding wire to form the ball (i.e., free air ball) and pressing this ball to the first lead-out portion 213.

The first connection electrode 400 may also be formed by plating a conductive metal. However, when a distance between the first coil pattern 210 and the first external electrode 700 is relatively large, it is not easy to form the first connection electrode 400 by plating. In this case, it may be advantageous to form the first connection electrode 400 by ball bonding the conductive wire as described above.

The first connection electrode 400 may include a first main body 410 and a first extension portion 420.

The first main body 410 may occupy a majority of the first connection electrode 400. The first main body 410 may include a first end portion 411 and a second end portion 413. The first end portion 411 may be a portion connected to the first external electrode 700, and the second end portion 413 may be a portion connected to the first extension portion 420.

The first extension portion 420 may be connected to the first lead-out portion 213 of the first coil pattern 210 and the second end portion 413 of the first main body 410. Accordingly, the first extension portion 420 may be disposed between the first lead-out portion 213 of the first coil pattern 210 and the first main body 410 of the first connection electrode 400. The first extension portion 420 may be thicker than the first main body 410. For example, a diameter of the first extension portion 420 may be greater than a diameter of the first main body 410.

In some embodiments, the first connection electrode 400 may be formed of the same material as the coil 200. For example, both the first connection electrode 400 and the coil 200 may include copper (Cu).

In some embodiments, the first connection electrode 400 may be formed of a different material from the coil 200. For example, the coil 200 may include copper (Cu), and the first connection electrode 400 may include gold (Au), aluminum (Al), silver (Ag), or an alloy thereof. When the first connection electrode 400 is formed of a different material from the coil 200, an intermetallic compound may be formed at an interface between the first connection electrode 400 and the coil 200. For example, an intermetallic compound may be disposed at an interface between the first extension portion 420 and the first lead-out portion 213.

The second connection electrode 500 may be disposed within magnetic body 100. For example, the second connection electrode 500 may be spaced apart from the second surface S2, the third surface S3 and the fourth surface S4 of the magnetic body 100.

As with the first connection electrode 400, the second connection electrode 500 may be a conductive wire. The conductive wire may be, for example, a bonding wire.

The second connection electrode 500 may include a second main body 510 and a second extension portion 520.

The second main body 510 may occupy a majority of the second connection electrode 500. The second main body 510 may include a first end portion 511 and a second end portion 513. The first end portion 511 may be a portion connected to second external electrode 800, and the second end portion 513 may be a portion connected to the second extension portion 520.

The second extension portion 520 may be connected to the second lead-out portion 223 of the second coil pattern 220 and the second end portion 513 of the second main body 510. That is, the second extension portion 520 may be connected to the second lead-out portion 223 of the second coil pattern 220 through the second via 240 and the connection portion 250. The connection portion 250 may be connected to the second via 240 and the second connection electrode 500, but may be electrically insulated from the first coil pattern 210.

Accordingly, the second extension portion 520 may be disposed between the second main body 510 of the second connection electrode 500 and the connection portion 250. The second extension portion 520 may be thicker than the second main body 510. For example, a diameter of the second extension portion 520 may be greater than a diameter of the second main body 510.

In some embodiments, second connection electrode 500 may be formed of the same material as the coil 200. For example, both the second connection electrode 500 and the coil 200 may include copper (Cu).

In some embodiments, second connection electrode 500 may be formed of a different material from the coil 200. For example, the coil 200 may include copper (Cu), and the second connection electrode 500 may include gold (Au), aluminum (Al), silver (Ag), or an alloy thereof. When the second connection electrode 500 is formed of a different material from the coil 200, an intermetallic compound may be formed at an interface between the second connection electrode 500 and the coil 200. For example, an intermetallic compound may be disposed at an interface between the second extension portion 520 and the connection portion 250.

Referring to FIG. 4, the first connection electrode 400 and the second connection electrode 500 may be disposed on a center line C-C′ that passes through a center of the magnetic body 100 in the width direction (the W-axis direction) and is parallel to the length direction (the L-axis direction).

The first external electrode 700 and the second external electrode 800 are disposed outside the magnetic body 100 and are connected to the coil 200.

The first external electrode 700 may be disposed on the sixth surface S6 of the magnetic body 100, and connected to the first lead-out portion 213 of the coil 200 through the first connection electrode 400. The second external electrode 800 may be disposed on the sixth surface S6 of the magnetic body 100, and connected to the second lead-out portion 223 of the coil 200 through the second connection electrode 500.

The first external electrode 700 may include a first metal layer 701, a second metal layer 702, and a third metal layer 703.

The first metal layer 701 is a plating layer that is in contact with the first connection electrode 400 and an outer surface, i.e., the sixth surface S6, of the magnetic body 100, and may include copper (Cu).

The second metal layer 702 is a plating layer covering the first metal layer 701 and may include nickel (Ni). The third metal layer 703 is a plating layer covering the second metal layer 702 and may include tin (Sn). However, the present embodiment is not limited to the three-layer structure described above, and a two-layer structure in which only one metal layer is added on the first metal layer 701 is also possible.

The second external electrode 800 may include a first metal layer 801, a second metal layer 802, and a third metal layer 803.

The first metal layer 801 is a plating layer that is in contact with the second connection electrode 500 and an outer surface, i.e., the sixth surface S6, of the magnetic body 100, and may include copper (Cu). The second metal layer 702 is a plating layer covering the first metal layer 701 and may include nickel (Ni). The third metal layer 703 is a plating layer covering the second metal layer 702 and may include tin (Sn). However, the present embodiment is not limited to the three-layer structure described above, and a two-layer structure in which only one metal layer is added on the first metal layer 701 is also possible.

As another example, the first external electrode 700 and the second external electrode 800 may include a conductive metal and glass. The conductive metal may be, for example, a conductive metal including copper (Cu), nickel (Ni), tin (Sn), palladium (Pd), platinum (Pt), gold (Au), silver (Ag), tungsten (W), titanium (Ti), lead (Pb), or an alloy thereof. The glass component included in the external electrodes 700 and 800 may be a mixture of oxides. The glass component may include, for example, a silicon oxide, a boron oxide, an aluminum oxide, a transition metal oxide, an alkali metal oxide, an alkaline-earth metal oxide, or a combination thereof. Here, the transition metal may be selected from zinc (Zn), titanium (Ti), copper (Cu), vanadium (V), manganese (Mn), iron (Fe), or nickel (Ni), the alkali metal may be selected from lithium (Li), sodium (Na), or potassium (K), and the alkaline-earth metal may be selected from magnesium (Mg), calcium (Ca), strontium (Sr), or barium (Ba). The forming method of the external electrodes 700 and 800 may not be particularly limited. For example, it may be formed by dipping a laminate into a conductive paste including a conductive metal and glass, or by printing a conductive paste on a surface of a laminate by, e.g., screen printing or gravure printing method. In addition, various methods, such as, applying a conductive paste on the surface of a laminate or transferring a dry film formed by drying the conductive paste to a laminate, may be used.

The surface insulation layer 900 may be disposed on the first surface S1, the second surface S2, the fifth surface S5 and the sixth surface S6 of the magnetic body 100. However, the surface insulation layer 900 may partially cover the sixth surface S6 of the magnetic body 100. That is, the first external electrode 700 and the second external electrode 800 may be disposed on the sixth surface S6 of the magnetic body 100, and the surface insulation layer 900 may not cover the first external electrode 700 and the second external electrode 800. Meanwhile, the surface insulation layer 900 may also be disposed on the third surface S3 and the fourth surface S4 of the magnetic body 100.

As described above, the surface insulation layer 900 may be disposed on at least a portion of the first surface S1, the second surface S2, the third surface S3, the fourth surface S4, the fifth surface S5 and the sixth surface S6 of the magnetic body 100 to prevent electrical shorts between other electronic components and the external electrodes 700 and 800.

The surface insulation layer 900 may be used as a resist when forming the external electrodes 700 and 800 by electroplating, but is not limited thereto.

The surface insulation layer may include polymer resin, pigment, filler, or the like. The polymer resin may be a thermosetting polymer resin such as epoxy or a thermoplastic polymer resin such as acryl. Pigments capable of producing color, such as black, may include carbon black, black manganese (Mn)-based spinel powder, etc., and the surface insulation layer may further include additives such as SiO₂ and talc, for control of strength and/or coefficient of thermal expansion.

For example, the surface insulation layer 900 may include a thermoplastic resin such as a polystyrene-based resin, a vinyl acetate-based resin, a polyester-based resin, a polyethylene-based resin, a polypropylene-based resin, a polyamide-based resin, a rubber-based resin, an acryl-based resin, or the like, a thermosetting resin such as a phenol-based resin, an epoxy-based resin, a urethane-based resin, a melamine-based resin, an alkyd-based resin, a photosensitive resin, parylene, SiOₓ or SiNₓ.

The surface insulation layer 900 may be formed through a process such as screen printing, pad printing, dipping, spray printing, or the like. For example, the surface insulation layer 900 may be formed, by applying a liquid insulating resin to a surface of the magnetic body 100, or by stacking an insulating film such as a dry film on the surface of the magnetic body 100, or through a thin film process such as vapor deposition. In the case of the insulating film, Ajinomoto Build-up Film (ABF) or polyimide film, or the like, which do not include a photosensitive insulating resin, may be used.

A thickness of the surface insulation layer 900 may be 3 μm or more and 25 μm or less. If the thickness of the surface insulation layer 900 is less than 3 μm, the magnetic body may be exposed in a portion where the surface insulation layer 900 is thin, which may cause, in an actual use environment, appearance problems such as oxidation. If the thickness of the surface insulation layer 900 exceeds 25 μm, the insulating properties may be excellent, but the volume of the magnetic body may be relatively decreased compared to the volume of the coil electronic component 1000, and accordingly, electrical properties such as inductance, direct current resistance, or rated current may deteriorate.

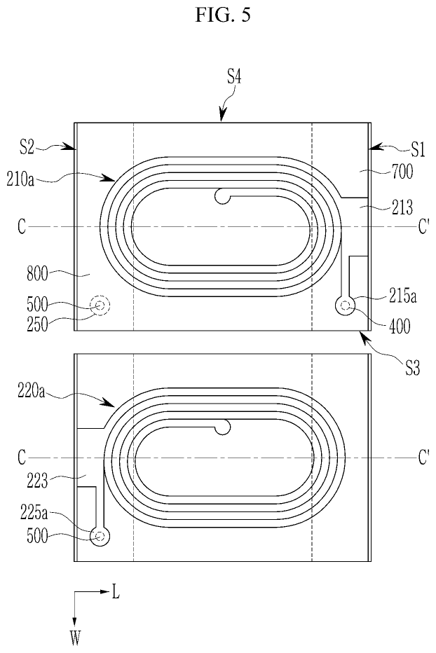

FIG. 5 is a drawing schematically showing a first coil pattern and a second coil pattern of a coil electronic component according to a modified example.

Referring to FIG. 5, a first coil pattern 210a may include a first extension portion 215a, and a second coil pattern 220a may include a second extension portion 225a.

The first extension portion 215a may be a structure extending from the first lead-out portion 213 toward the third surface S3 of the magnetic body 100, and may be connected to the first connection electrode 400. The second extension portion 225a may be a structure extending from the second lead-out portion 223 toward the third surface S3 of the magnetic body 100, and may be connected to the second connection electrode 500.

As described above, the first connection electrode 400 and the second connection electrode 500 may be disposed to be biased toward the third surface S3 of the magnetic body 100 with respect to the center line C-C′. In comparison with the embodiment shown in FIG. 4, in the present modified example, the first connection electrode 400 may not be directly connected to the first lead-out portion 213, and the second connection electrode 500 may not be directly connected to the second lead-out portion 223. Accordingly, the size of the first lead-out portion 213 and the second lead-out portion 223 may be decreased, and the area of the coil may be increased accordingly. Thus, the capacity of the coil electronic component can be increased.

Components except for the above-described components are the same as those of the coil electronic component shown in FIG. 1, so redundant descriptions thereof will be omitted.

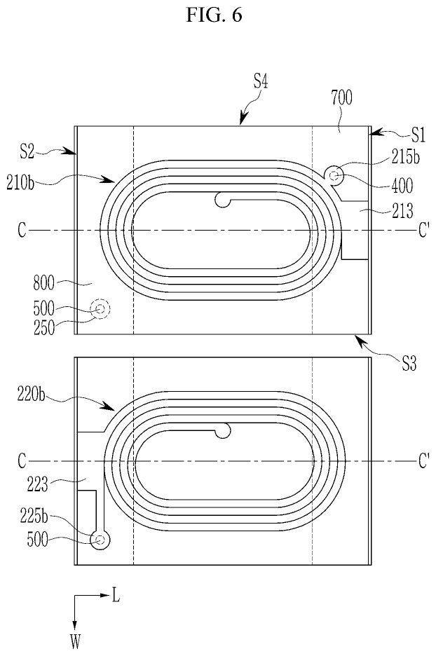

FIG. 6 is a drawing schematically showing a first coil pattern and a second coil pattern of a coil electronic component according to another modified example.

Referring to FIG. 6, a first coil pattern 210b may include a first protruding portion 215b, and a second coil pattern 220b may include a second extension portion 225b.

The first protruding portion 215b may be a structure protruding from the first coil pattern 210b near the first lead-out portion 213 toward a point where the first surface S1 and the fourth surface S4 of the magnetic body 100 meet each other, and may be connected to the first connection electrode 400. The second extension portion 225b may be a structure extending from the second lead-out portion 223 of the second coil pattern 220b toward the third surface S3 of the magnetic body 100, and may be connected to the second connection electrode 500.

As described above, the first connection electrode 400 and the second connection electrode 500 may be disposed staggered from each other with respect to the center line C-C′. That is, the first connection electrode 400 may be disposed to be biased toward the fourth surface S4 of the magnetic body 100, and the second connection electrode 500 may be disposed to be biased toward the third surface S3. The effect of such an arrangement may be the same as or similar to the effect of the modified example of FIG. 5.

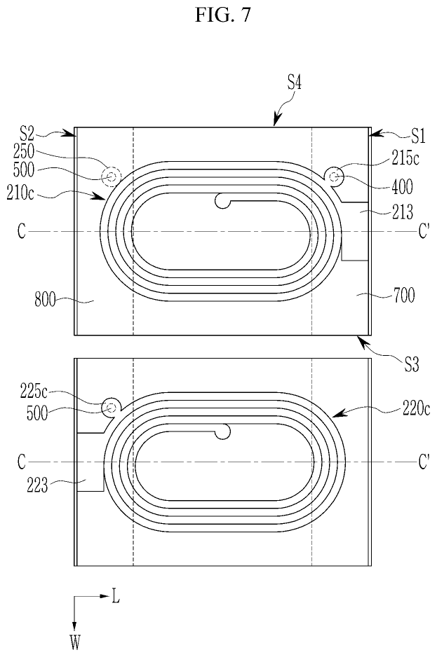

FIG. 7 is a drawing schematically showing a first coil pattern and a second coil pattern of a coil electronic component according to still another modified example.

Referring to FIG. 7, a first coil pattern 210c may include a first protruding portion 215c, and a second coil pattern 220c may include a second protruding portion 225c.

The first protruding portion 215c may be a structure protruding from the first coil pattern 210c near the first lead-out portion 213 toward a point where the first surface S1 and the fourth surface S4 of the magnetic body 100 meet each other, and may be connected to the first connection electrode 400. The second protruding portion 225c may be a structure protruding from the second coil pattern 220c near the second lead-out portion 223 toward a point where the second surface S2 and the fourth surface S4 of the magnetic body 100 meet each other, and may be connected to the second connection electrode 500.

As described above, the first connection electrode 400 and the second connection electrode 500 may be disposed to be biased toward the fourth surface S4 of the magnetic body 100 with respect to the center line C-C′. The effect of such an arrangement may be the same as or similar to the effect of the modified example of FIG. 5.

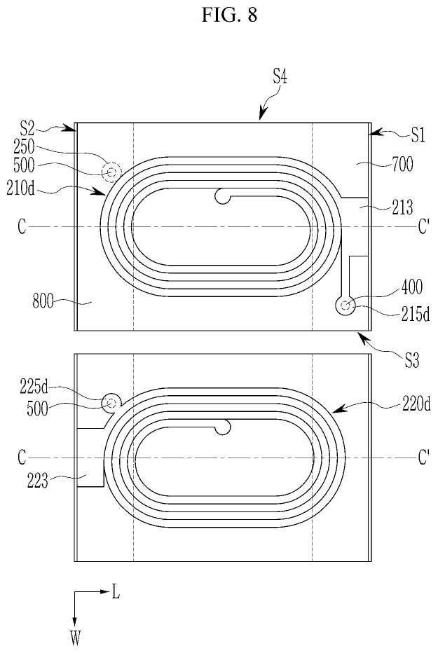

FIG. 8 is a drawing schematically showing a first coil pattern and a second coil pattern of a coil electronic component according to another modified example.

Referring to FIG. 8, a first coil pattern 210d may include a first extension portion 215d, and a second coil pattern 220d may include a second protruding portion 225d.

The first extension portion 215d may be a structure extending from the first lead-out portion 213 toward the third surface S3 of the magnetic body 100, and may be connected to the first connection electrode 400. The second protruding portion 225d may be a structure extending from the second coil pattern 220d near the second lead-out portion 223 toward a point where the second surface S3 and the fourth surface S4 of the magnetic body 100 meet each other, and may be connected to the second connection electrode 500.

As such, the first connection electrode 400 and the second connection electrode 500 may be disposed staggered from each other with respect to the center line C-C′. That is, the first connection electrode 400 may be disposed to be biased toward the third surface S3 of the magnetic body 100, and the second connection electrode 500 may be disposed to be biased toward the fourth surface S4. The effect of such an arrangement may be the same as or similar to the effect of the modified example of FIG. 5.

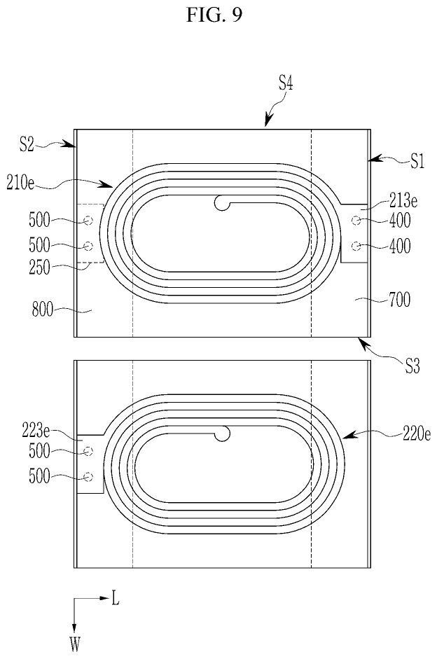

FIG. 9 is a drawing schematically showing a first coil pattern and a second coil pattern of a coil electronic component according to still another modified example.

Referring to FIG. 9, a first coil pattern 210e may be connected to the first external electrode 700 through two first connection electrodes 400, and a second coil pattern 220e may be connected to the second external electrode 800 through two second connection electrodes 500.

That is, the first coil pattern 210e may include a first lead-out portion 213e, and the two first connection electrodes 400 may be connected to the first lead-out portion 213e. The two first connection electrodes 400 may also be connected to the first external electrode 700.

In addition, the second coil pattern 220e may include a second lead-out portion 223e, and the two second connection electrodes 500 may be connected to the second lead-out portion 223e. The two second connection electrodes 500 may also be connected to the second external electrode 800.

A diameter of the bonding wire that is used as the connection electrode may be 8 μm or more and 500 μm or less. Using a bonding wire with a larger diameter is advantageous due to its lower resistance, but if it is difficult to use a bonding wire with a larger diameter due to space constraints, two connection electrodes with smaller diameters may be used together to further reduce direct current resistance (Rdc).

The number of connection electrodes may not be limited two, and more connection electrodes may be used as needed.

Components except for the above-described components are the same as those of the coil electronic component shown in FIG. 1, so redundant descriptions thereof will be omitted.

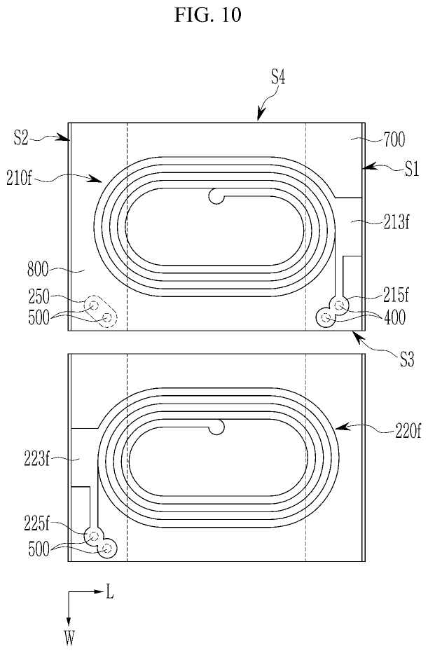

FIG. 10 is a drawing schematically showing a first coil pattern and a second coil pattern of a coil electronic component according to still another modified example.

Referring to FIG. 10, a first coil pattern 210f may include a first extension portion 215f, and a second coil pattern 220f may include a second extension portion 225f.

The first extension portion 215f may be a structure extending from a first lead-out portion 213f toward the third surface S3 of the magnetic body 100, and may be connected to two first connection electrodes 400. The second extension portion 225f may be a structure extending from a second lead-out portion 223f toward the third surface S3 of the magnetic body 100, and may be connected to two second connection electrodes 500.

Components except for the above-described components are the same as those of the coil electronic component shown in FIG. 5, so redundant descriptions thereof will be omitted.

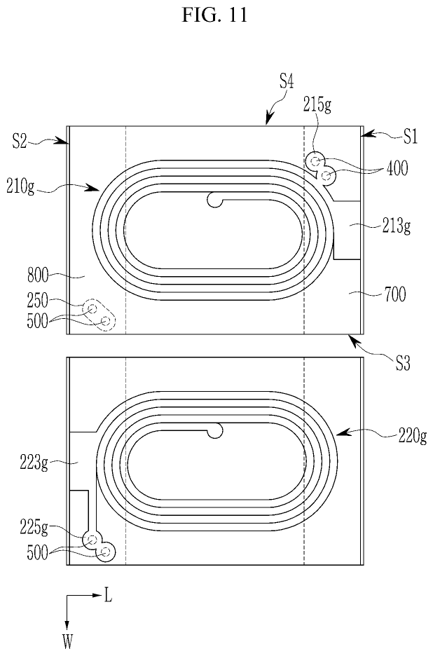

FIG. 11 is a drawing schematically showing a first coil pattern and a second coil pattern of a coil electronic component according to still another modified example.

Referring to FIG. 11, a first coil pattern 210g may include a first protruding portion 215g, and a second coil pattern 220g may include a second extension portion 225g.

The first protruding portion 215g may be a structure extending from the first coil pattern 210g near a first lead-out portion 213g toward a point where the first surface S1 and the fourth surface S4 of the magnetic body 100 meet each other, and may be connected to two first connection electrodes 400. The second extension portion 225g may be a structure extending from a second lead-out portion 223g toward the third surface S3 of the magnetic body 100, and may be connected to the second connection electrodes 500.

Components except for the above-described components are the same as those of the coil electronic component shown in FIG. 6, so redundant descriptions thereof will be omitted.

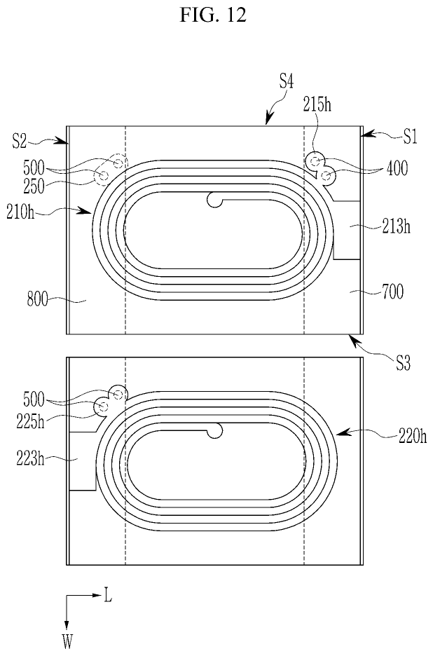

FIG. 12 is a drawing schematically showing a first coil pattern and a second coil pattern of a coil electronic component according to still another modified example.

Referring to FIG. 12, a first coil pattern 210h may include a first protruding portion 215h, and a second coil pattern 220h may include a second protruding portion 225h.

The first protruding portion 215h may be a structure protruding from the first coil pattern 210h near a first lead-out portion 213h toward a point where the first surface S1 and the fourth surface S4 of the magnetic body 100 meet each other, and may be connected to two first connection electrodes 400. The second protruding portion 225h may be a structure protruding from the second coil pattern 220h near a second lead-out portion 223h toward a point where the second surface S2 and the fourth surface S4 of the magnetic body 100 meet each other, and may be connected to two second connection electrodes 500.

Components except for the above-described components are the same as those of the coil electronic component shown in FIG. 7, so redundant descriptions thereof will be omitted.

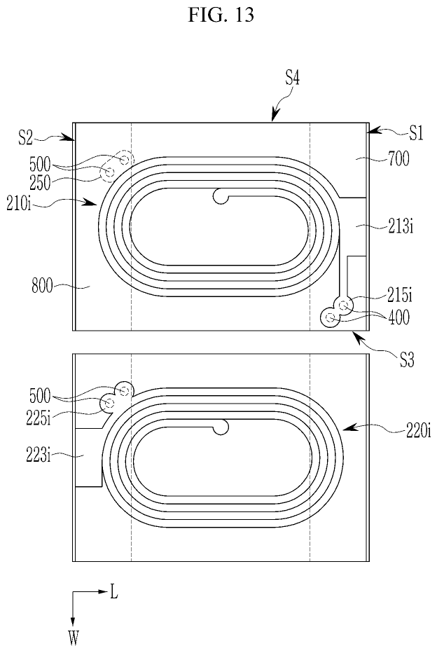

FIG. 13 is a drawing schematically showing a first coil pattern and a second coil pattern of a coil electronic component according to still another modified example.

Referring to FIG. 13, a first coil pattern 210i may include a first extension portion 215i, and the second coil pattern 220a may include a second protruding portion 225i.

The first extension portion 215i may be a structure extending from a first lead-out portion 213i toward the third surface S3 of the magnetic body 100, and may be connected to two first connection electrodes 400. The second protruding portion 225i may be a structure extending from the second coil pattern 220a near a second lead-out portion 223i toward a point where the second surface S3 and the fourth surface S3 of the magnetic body 100 meet each other, and may be connected to two second connection electrodes 500.

Components except for the above-described components are the same as those of the coil electronic component shown in FIG. 8, so redundant descriptions thereof will be omitted.

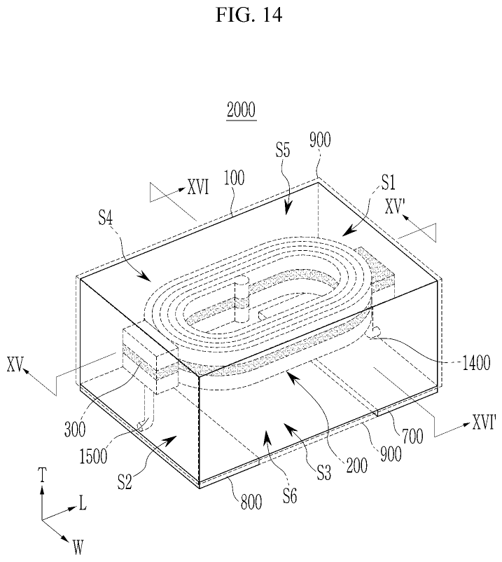

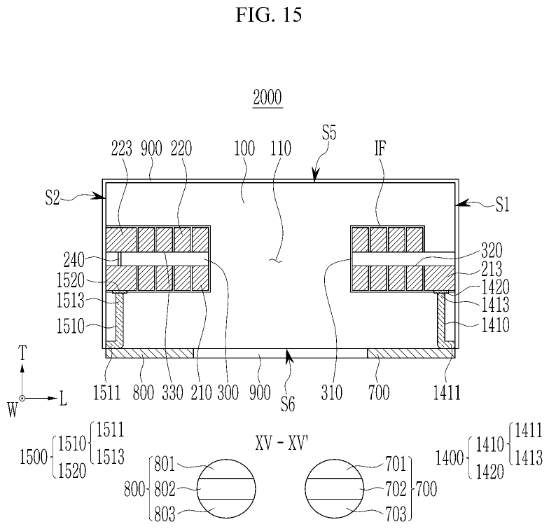

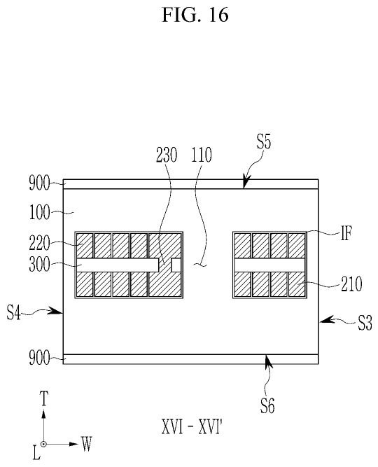

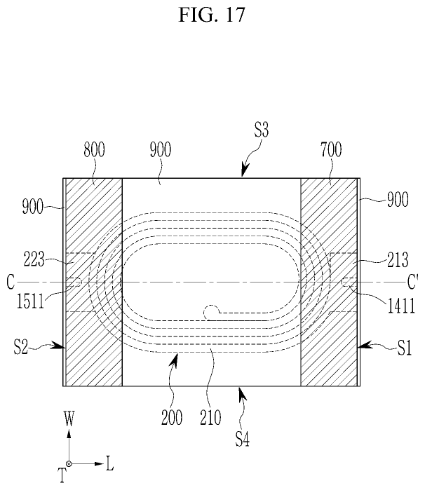

FIG. 14 is a perspective view schematically showing a coil electronic component according to another embodiment. FIG. 15 is a schematic cross-sectional view taken along line XV-XV′ of FIG. 14. FIG. 16 is a schematic cross-sectional view taken along line XVI-XVI′ of FIG. 14. FIG. 17 is a bottom view schematically showing the coil electronic component of FIG. 14.

Components except for a first connection electrode 1400 and a second connection electrode 1500 of a coil electronic component 2000 are the same as the component of the coil electronic component of FIG. 1, and a redundant description thereof will be omitted.

The first connection electrode 1400 may include a first main body 1410, a first bent portion 1411, and a first extension portion 1420.

The first main body 1410 may occupy a majority of the first connection electrode 1400, and may be spaced apart from the first surface S1 of the magnetic body 100. The first bent portion 1411 may be connected to one end of the first main body 1410, and the first extension portion 1420 may be connected to the other end thereof.

The first bent portion 1411 may be a portion connected to the first external electrode 700. The first bent portion 1411 may be in contact with the first external electrode 700, and may extend to the first surface S1 of the magnetic body 100 along the length direction (the L-axis direction). The first main body 1410 is spaced apart from the first surface S1 of the magnetic body 100, while the first bent portion 1411 may be in contact with the first surface S1 of the magnetic body 100. Therefore, compared to the case without the first bent portion 1411, an area over which the first connection electrode 1400 is in contact with the first external electrode 700 may be larger.

The first extension portion 1420 may be connected to the first lead-out portion 213 of the first coil pattern 210. Accordingly, the first extension portion 1420 may be disposed between the first lead-out portion 213 of the first coil pattern 210 and the first main body 1410 of the first connection electrode 1400. The first extension portion 1420 may be thicker than the first main body 1410. For example, a diameter of the first extension portion 1420 may be greater than a diameter of the first main body 1410.

The second connection electrode 1500 may include a second main body 1510, a second bent portion 1511, and a second extension portion 1520.

The second main body 1510 may occupy a majority of the second connection electrode 1500, and may be spaced apart from the second surface S2 of the magnetic body 100. The second bent portion 1511 may be connected to one end of the second main body 1510, and the second extension portion 1520 may be connected to the other end thereof.

The second bent portion 1511 may be a portion connected to the second external electrode 800. The second bent portion 1511 may be in contact with the second external electrode 800, and may extend to the second surface S2 of the magnetic body 100 along the length direction (the L-axis direction). The first main body 1410 is spaced apart from the second surface S2 of the magnetic body 100, while the second bent portion 1511 may be in contact with the second surface S2 of the magnetic body 100. Therefore, compared to the case without the second bent portion 1511, an area over which the second connection electrode 1500 is in contact with the second external electrode 800 may be larger.

The second extension portion 1520 may be connected to the second lead-out portion 223 of the second coil pattern 220 through the second via 240. Accordingly, the second extension portion 1520 may be disposed between the second main body 1510 of the second connection electrode 1500 and the second via 240. The second extension portion 1520 may be thicker than the second main body 1510. For example, a diameter of the second extension portion 1520 may be greater than a diameter of the second main body 1510.

The first connection electrode 1400 and the second connection electrode 1500 may be a conductive wire. The conductive wire may be, for example, a bonding wire.

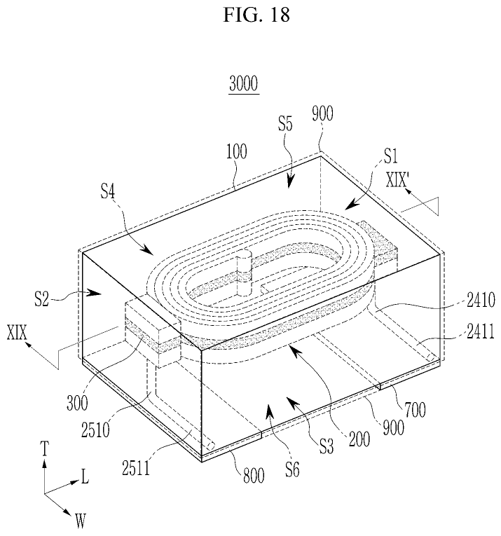

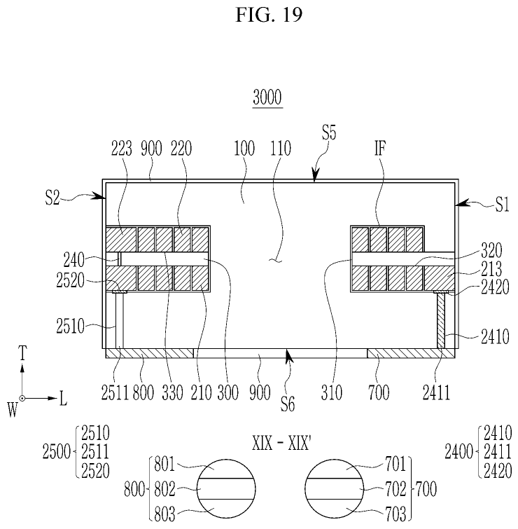

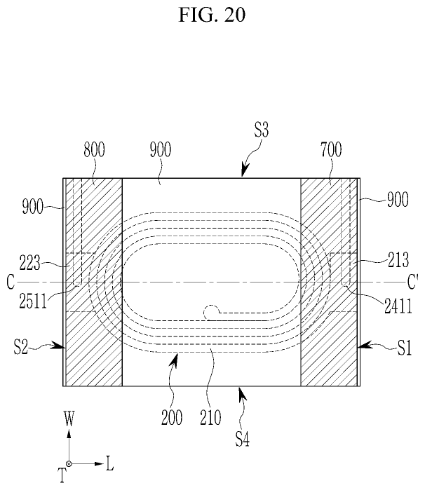

FIG. 18 is a perspective view schematically showing a coil electronic component according to still another embodiment. FIG. 19 is a schematic cross-sectional view taken along line XIX-XIX′ of FIG. 18. FIG. 20 is a bottom view schematically showing the coil electronic component of FIG. 18.

Components except for a first connection electrode 2400 and a second connection electrode 2500 of a coil electronic component 3000 are the same as the component of the coil electronic component of FIG. 1, and a redundant description thereof will be omitted.

The first connection electrode 2400 may include a first main body 2410, a first bent portion 2411, and a first extension portion 2420.

The first main body 2410 may occupy a majority of the first connection electrode 2400, and may be spaced apart from the first surface S1 of the magnetic body 100. The first bent portion 2411 may be connected to one end of the first main body 2410, and the first extension portion 2420 may be connected to the other end thereof.

The first bent portion 2411 may be a portion connected to the first external electrode 700. The first bent portion 2411 may be in contact with the first external electrode 700, and may extend to the third surface S3 of the magnetic body 100 along the width direction (the W-axis direction). The first main body 2410 is spaced apart from the third surface S3 of the magnetic body 100, while the first bent portion 2411 may be in contact with the third surface S3 of the magnetic body 100. Therefore, compared to the case without the first bent portion 2411, an area over which the first connection electrode 2400 is in contact with the first external electrode 700 may be larger.

The first extension portion 2420 may be connected to the first lead-out portion 213 of the first coil pattern 210. Accordingly, the first extension portion 2420 may be disposed between the first lead-out portion 213 of the first coil pattern 210 and the first main body 2410 of the first connection electrode 2400. The first extension portion 2420 may be thicker than the first main body 2410. For example, a diameter of the first extension portion 2420 may be greater than a diameter of the first main body 2410.

The second connection electrode 2500 may include a second main body 2510, a second bent portion 2511, and a second extension portion 2520.

The second main body 2510 may occupy a majority of the second connection electrode 2500, and may be spaced apart from the second surface S2 of the magnetic body 100. The second bent portion 2511 may be connected to one end of the second main body 2510, and the second extension portion 2520 may be connected to the other end thereof.

The second bent portion 2511 may be a portion connected to the second external electrode 800. The second bent portion 2511 may be in contact with the second external electrode 800, and may extend to the third surface S3 of the magnetic body 100. The first main body 2410 is spaced apart from the third surface S3 of the magnetic body 100, while the second bent portion 2511 may be in contact with the third surface S3 of the magnetic body 100. Therefore, compared to the case without the second bent portion 2511, an area over which the second connection electrode 2500 is in contact with the second external electrode 800 may be larger.

The second extension portion 2520 may be connected to the second lead-out portion 223 of the second coil pattern 220 through the second via 240. Accordingly, the second extension portion 2520 may be disposed between the second main body 2510 of the second connection electrode 2500 and the second via 240. The second extension portion 2520 may be thicker than the second main body 2510. For example, a diameter of the second extension portion 2520 may be greater than a diameter of the second main body 2510.

The first connection electrode 1400 and the second connection electrode 1500 may be a conductive wire. The conductive wire may be, for example, a bonding wire.

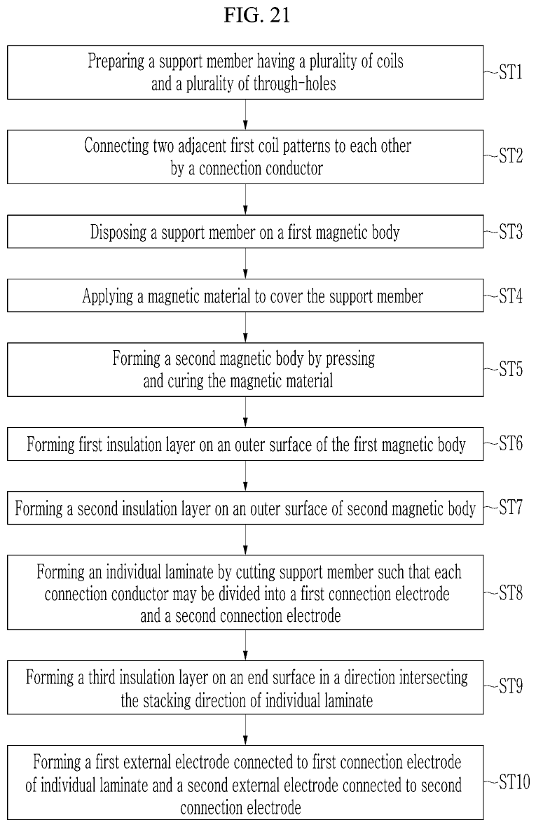

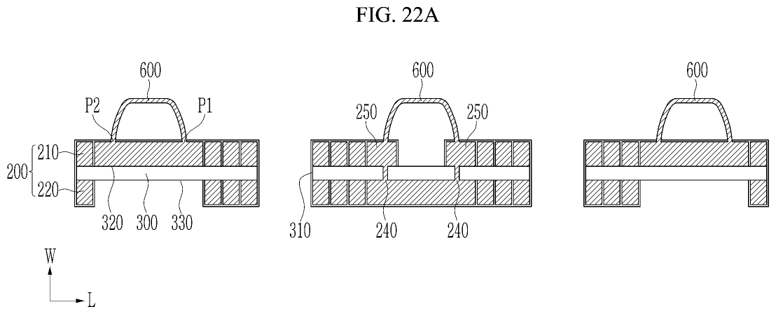

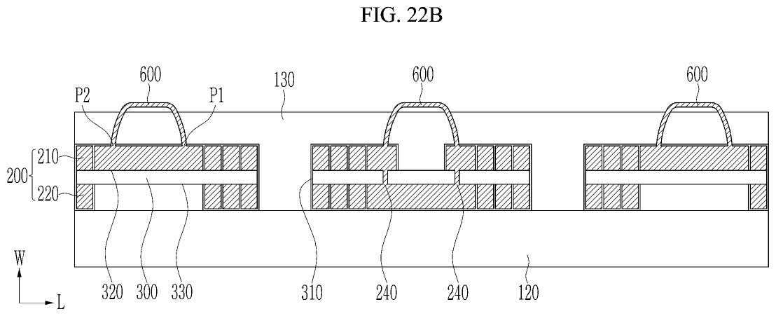

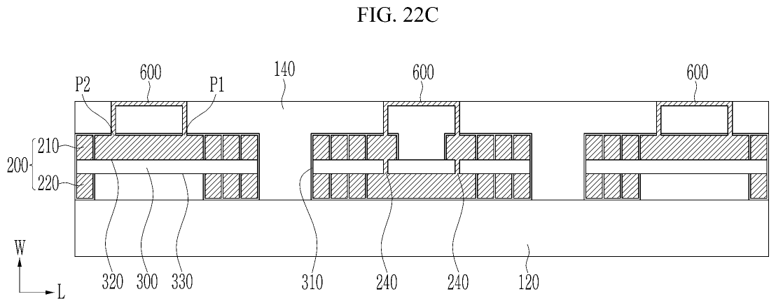

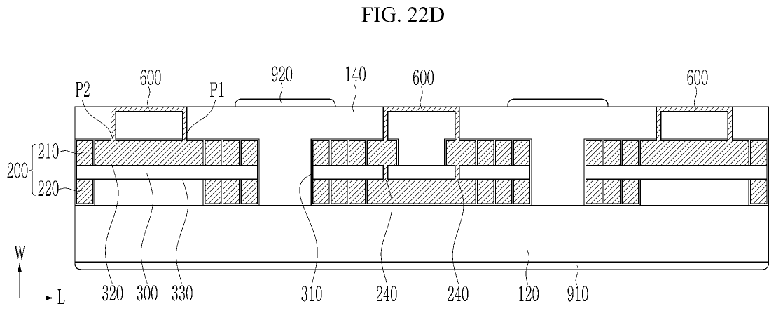

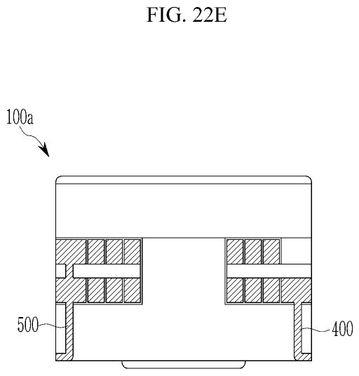

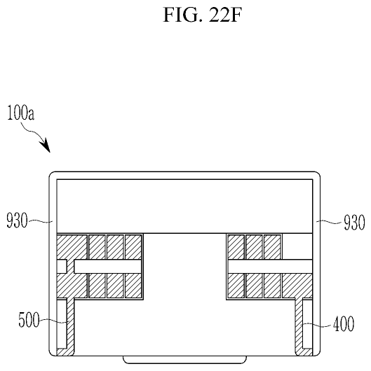

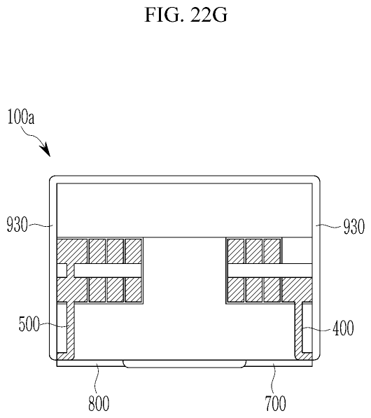

FIG. 21 is a flowchart showing a manufacturing method of a coil electronic component according to an embodiment. FIG. 22A to FIG. 22G are drawings sequentially showing the manufacturing method of a coil electronic component according to an embodiment.

Referring to FIG. 21, a manufacturing method of a coil electronic component according to an embodiment may include a step ST1 of preparing a support member having a plurality of coils and a plurality of through-holes; a step ST2 of connecting two adjacent first coil patterns to each other by a connection conductor; a step ST3 of disposing the support member on a first magnetic body; a step ST4 of applying a magnetic material to cover the support member; a step ST5 of forming a second magnetic body by pressing and curing the magnetic material; a step ST6 of forming a first insulation layer on an outer surface of the first magnetic body; a step ST7 of forming a second insulation layer on an outer surface of the second magnetic body; a step ST8 of forming an individual laminate by dicing the support member such that each connection conductor may be divided into a first connection electrode and a second connection electrode; a step ST9 of forming a third insulation layer on a diced surface of the individual laminate, i.e., an end surface in a direction along which the support member is diced to form the individual laminate; and a step ST10 of forming a first external electrode connected to the first connection electrode of the individual laminate and a second external electrode connected to the second connection electrode.

At the step ST1, each coil may include a first coil pattern disposed on the first surface of the support member with respect to the through-hole, and a second coil pattern disposed on the second surface of the support member and connected to the first coil pattern through a via.

At the step ST4, a portion of the connection conductor may be exposed.

At the step ST7, the second insulation layer may be formed to be spaced apart from the exposed portion of the connection conductor.

Referring to FIG. 22A, the support member 300 may include a plurality of coils 200 and a plurality of through-holes 310. Each coil 200 may include the first coil pattern 210 disposed on the first support surface 320 of the support member 300 with respect to the through-hole 310, and the second coil pattern 220 disposed on the second support surface 330 of the support member 300 and connected to the first coil pattern 210 through the first via 230. Two first coil patterns 210 that are adjacent in the length direction (the L-axis direction) may be connected to each other through a connection conductor 600.

The connection conductor 600 may be a bonding wire. For example, ball bonding may be performed by melting one end of the bonding wire to form a ball (i.e., free air ball) and pressing this ball to a first point P1, which will be the first lead-out portion 213 of the first coil pattern 210, and pressing the other end of the bonding wire toward a second point P2 spaced apart from the first point P1. In addition, ball bonding may be performed by pressing the ball of a bonding wire toward a connection portion 250, and by pressing the other end of the bonding wire toward another connection portion 250. Before performing ball bonding, the process of removing the insulation layer IF (see FIG. 2) may be performed by radiating a laser beam to the first point P1 and the second point P2 of the first coil pattern 210.

Referring to FIG. 22B, the support member 300 may be disposed on a first magnetic body 120. In this case, the second coil pattern 220 may be in contact with a surface of the first magnetic body 120. Subsequently, a magnetic material 130 may be applied to cover the support member 300. The magnetic material 130 may fill the through-hole 310 of the support member 300, and may cover both the first coil pattern 210 and the second coil pattern 220. Meanwhile, when applying the magnetic material 130, a portion of the connection conductor 600 may be exposed.

In some embodiments, the first magnetic body 120 may include the same material as the magnetic material 130. In some embodiments, the material of the first magnetic body 120 may be different from the magnetic material 130.

Referring to FIG. 22C, a second magnetic body 140 may be formed by pressing and curing the magnetic material 130. During this process, the exposed portion of the connection conductor 600 may be pressed to form a flush surface with a surface of the second magnetic body 140.

Referring to FIG. 22D, a first insulation layer 910 may be formed on an outer surface of the first magnetic body 120, and a second insulation layer 920 may be formed on an outer surface of the second magnetic body 140. The second insulation layer 920 may be formed to be spaced apart from the exposed portion of the connection conductor 600.

Referring to FIG. 22E, an individual laminate 100a may be formed by dicing the structure shown in FIG. 22D such that each connection conductor 600 may be divided into a first connection electrode 400 and a second connection electrode 500.

Referring to FIG. 22F, a third insulation layer 930 may be formed on a diced surface of the individual laminate 100a, i.e., an end surface in a direction along which the structure shown in FIG. 22D is diced to form the individual laminate 100a.

Referring to FIG. 22G, a first external electrode 700 that is connected to the first connection electrode 400 of the individual laminate 100a may be formed, and a second external electrode 800 that is connected to the second connection electrode 500 may be formed. The finally manufactured coil electronic component may correspond to the coil electronic component shown in FIG. 15.

Except for the above, a redundant description of a part having the same features as a coil electronic component according to the above-described embodiment will be omitted.

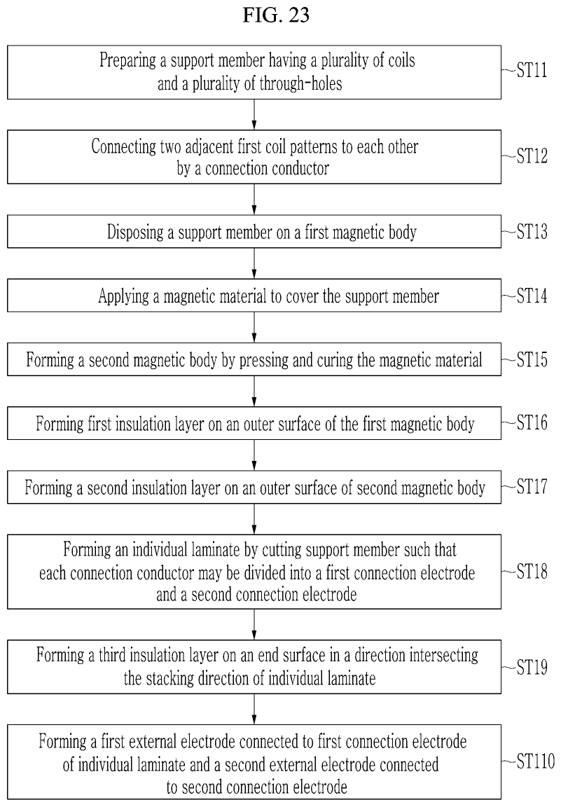

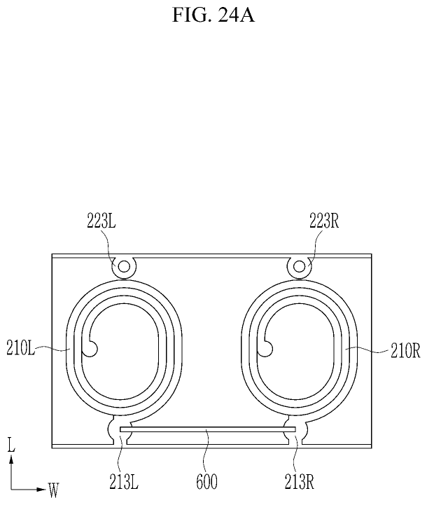

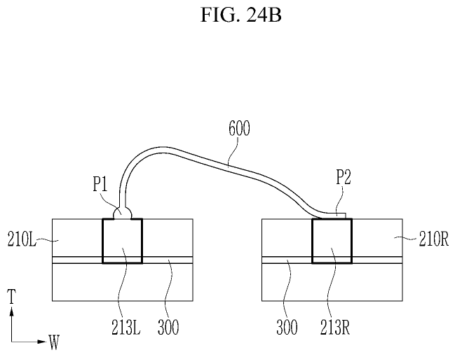

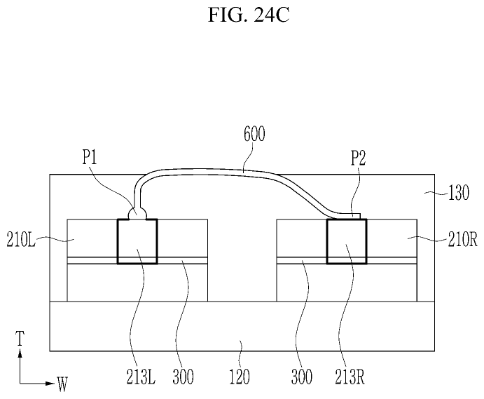

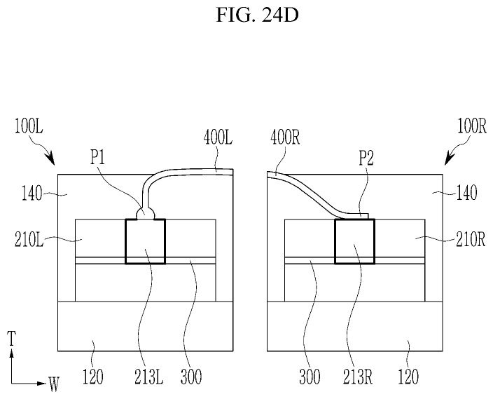

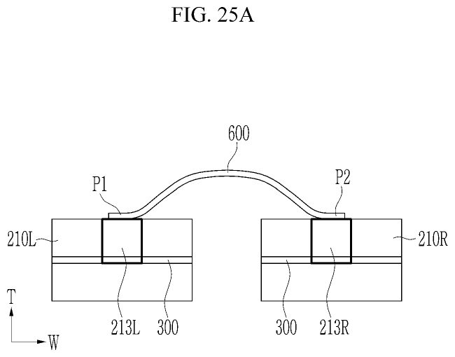

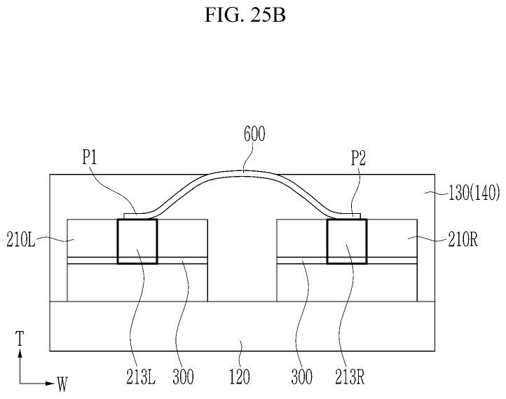

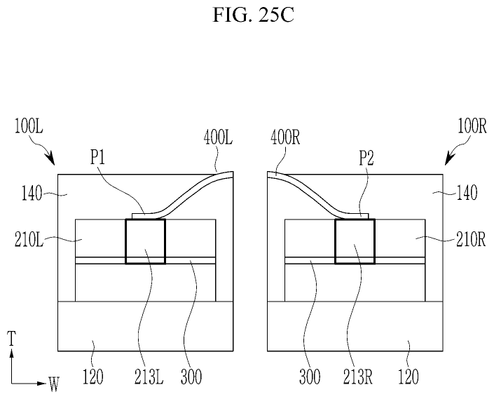

FIG. 23 is a flowchart showing a manufacturing method of a coil electronic component according to another embodiment. FIG. 24A to FIG. 24D are drawings sequentially showing a manufacturing method of a coil electronic component by using a ball bonding wire. FIG. 25A to FIG. 25C are drawings sequentially showing a manufacturing method of a coil electronic component by using a wedge wire bonding.

Referring to FIG. 23, a manufacturing method of a coil electronic component may include a step ST11 of preparing a support member having a plurality of coils and a plurality of through-holes; a step ST12 of connecting two adjacent first coil patterns to each other by a connection conductor; a step ST13 of disposing the support member on a first magnetic body; a step ST14 of applying a magnetic material to cover the support member; a step ST15 of forming a second magnetic body by pressing and curing the magnetic material; a step ST16 of forming a first insulation layer on an outer surface of the first magnetic body; a step ST17 of forming a second insulation layer on an outer surface of the second magnetic body; a step ST18 of forming an individual laminate by dicing the support member such that each connection conductor may be divided into two first connection electrodes; a step ST19 of forming a third insulation layer on a diced surface of the individual laminate, i.e., an end surface in a direction along which the support member is diced to form the individual laminate; and a step ST110 of forming a first external electrode connected to the first connection electrode of the individual laminate and a second external electrode connected to the second connection electrode.

Referring to FIG. 24A and FIG. 24B, two adjacent first coil patterns 210L and 210R the in the width direction (the W-axis direction) may be connected to each other through a connection conductor 600.

The connection conductor 600 may be a ball bonding wire. For example, ball bonding may be performed by melting one end of the bonding wire to form a ball (i.e., free air ball), and pressing this ball to the first point P1, which will be a first lead-out portion 213L of the first coil pattern 210L, and pressing the other end of the bonding wire to the second point P2, which will be a first lead-out portion 213R of another first coil pattern 210R. Before performing ball bonding, the process of removing the insulation layer IF (see FIG. 2) may be performed by radiating a laser beam to the first point P1 of the first coil pattern 210L and the second point P2 of the first coil pattern 210R. The points that will be the connection portions to be connected to each of second lead-out portions of the first coil pattern 210L and the first coil pattern 210R may also be ball-bonded in a similar manner.

Referring to FIG. 24C, the support member 300 may be disposed on the first magnetic body 120, and the magnetic material 130 may be applied to cover the support member 300. When applying the magnetic material 130, a portion of the connection conductor 600 may be exposed. Thereafter, the second magnetic body 140 may be formed by pressing and curing the magnetic material 130.

Referring to FIG. 24D, individual laminates 100L and 100R may be formed by dicing the support member 300 such that each connection conductor may be divided into two first connection electrodes 400L and 400R.

Referring to FIG. 25A, two adjacent first coil patterns 210L and 210R in the width direction (the W-axis direction) may be connected to each other through a connection conductor 600.

The connection conductor 600 may be a wedge bonding wire. For example, wedge bonding may be performed by performing stitch bonding by pressing one end of the bonding wire to the first point P1, which will be the first lead-out portion 213L of the first coil pattern 210L, and by performing stitch bonding by pressing the other end of the bonding wire to the second point P2, which will be still another first lead-out portion 213R of the first coil pattern 210R. Before performing wedge bonding, the process of removing the insulation layer IF (see FIG. 2) may be performed by radiating a laser beam to the first point P1 of the first coil pattern 210L and the second point P2 of the second coil pattern 210R. The points that will be the connection portions to be connected to second lead-out portions of the first coil pattern 210L and the first coil pattern 210R may also be wedge bonded in a similar manner.

Referring to FIG. 25B, the support member 300 may be disposed on the first magnetic body 120, and the magnetic material 130 may be applied to cover the support member 300. When applying the magnetic material 130, a portion of the connection conductor 600 may be exposed. Thereafter, the second magnetic body 140 may be formed by pressing and curing the magnetic material 130.

Referring to FIG. 25C, individual laminates 100L and 100R may be formed by dicing the support member 300 such that each connection conductor may be divided into two first connection electrodes 400L and 400R.

Steps except for the above are the same as the steps of FIG. 21, so a redundant description thereof will be omitted.

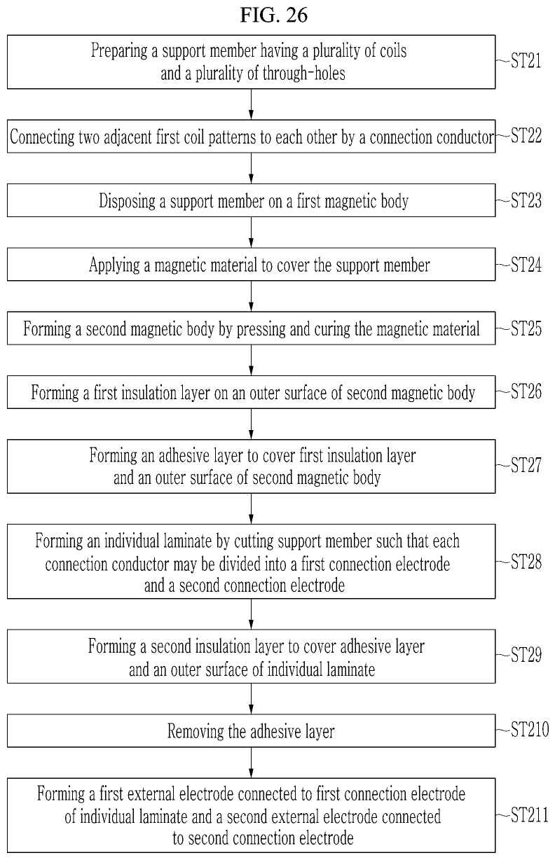

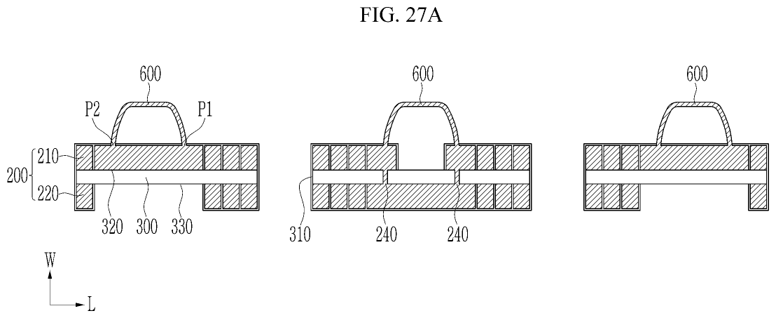

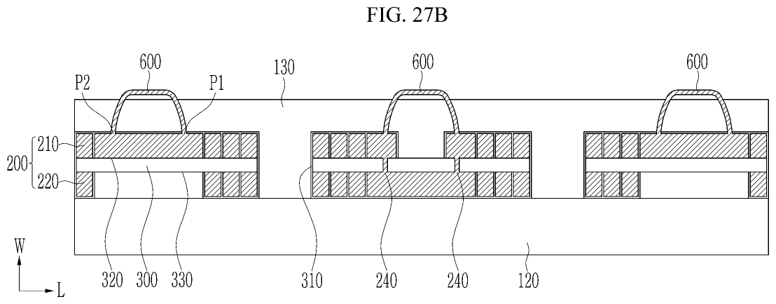

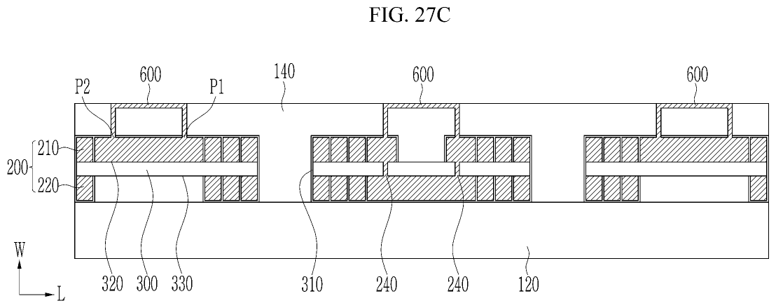

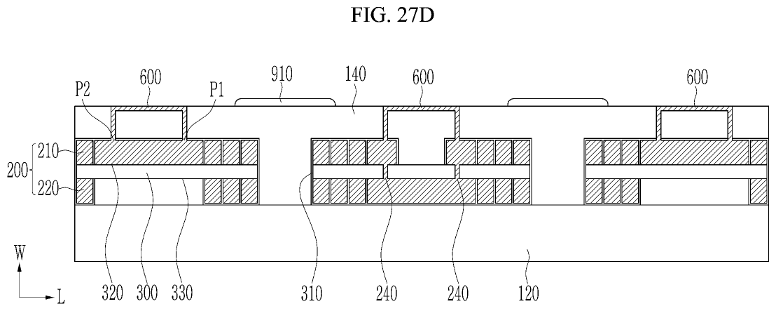

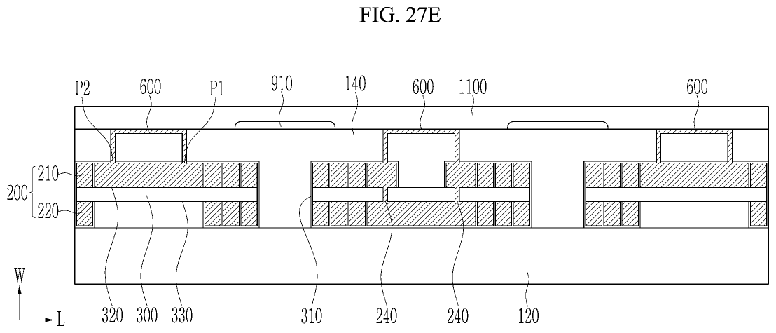

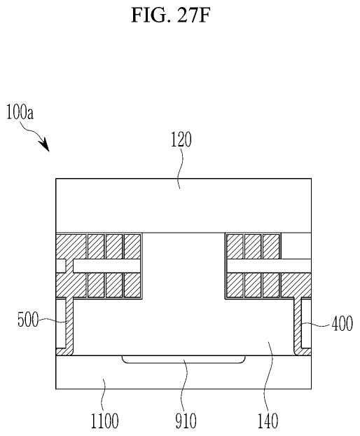

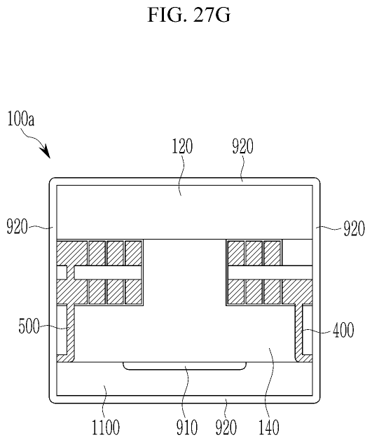

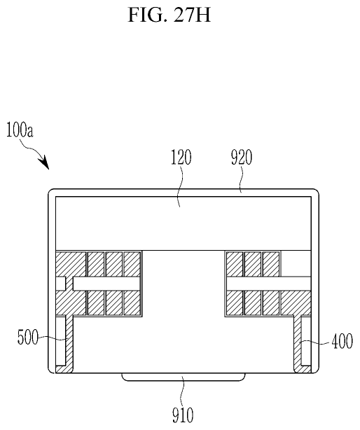

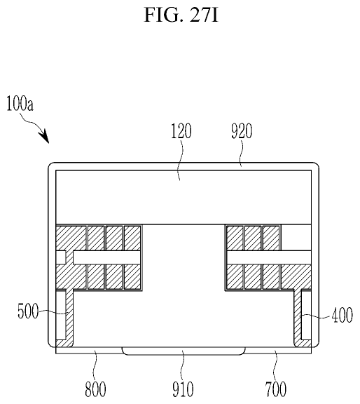

FIG. 26 is a flowchart showing a manufacturing method of a coil electronic component according to another embodiment. FIG. 27A to FIG. 27I are drawings sequentially showing a manufacturing method of a coil electronic component according to another embodiment.

Referring to FIG. 26, a manufacturing method of a coil electronic component may include a step ST21 of preparing a support member having a plurality of coils and a plurality of through-holes; a step ST22 of connecting two adjacent first coil patterns to each other by a connection conductor; a step ST23 of disposing the support member on a first magnetic body; a step ST24 of applying a magnetic material to cover the support member; a step ST25 of forming a second magnetic body by pressing and curing the magnetic material; a step ST26 of forming a first insulation layer on an outer surface of the second magnetic body; a step ST27 of forming an adhesive layer to cover the first insulation layer and an outer surface of the second magnetic body; a step ST28 of forming an individual laminate by dicing the support member such that each connection conductor may be divided into a first connection electrode and a second connection electrode; a step ST29 of forming a second insulation layer to cover the adhesive layer and an outer surface of the individual laminate; a step ST210 of removing the adhesive layer; and a step ST211 of forming a first external electrode connected to the first connection electrode of the individual laminate and a second external electrode connected to the second connection electrode of the individual laminate.

FIG. 27A, FIG. 27B, and FIG. 27C represent the step ST21, the step ST22, the step ST23, the step ST24, and the step ST25, respectively, and these are the same as the steps of the embodiments shown in FIG. 21, so a redundant description thereof will be omitted.

Referring to FIG. 27D, a first insulation layer 910 may be formed on an outer surface of the second magnetic body 140. The first insulation layer 910 may be formed to be spaced apart from the exposed portion of the connection conductor 600.

Referring to FIG. 27E, an adhesive layer 1100 may be formed to cover the first insulation layer 910 and the outer surface of the second magnetic body 140. For example, the adhesive layer may be formed using drum coating or fluidized bed spraying. The adhesive layer may include a thermoplastic resin that contains a spherical foaming agent therein.

Referring to FIG. 27F, an individual laminate 100a may be formed by dicing the support member 300 such that each connection conductor may be divided into a first connection electrode 400 and a second connection electrode 500. Here, the adhesive layer 1100 may cover the first insulation layer 910 and the outer surface of the second magnetic body 140.

Referring to FIG. 27G, a second insulation layer 920 may be formed to cover the adhesive layer 1100 and an outer surface of the individual laminate 100a.

Referring to FIG. 27H, the adhesive layer may be removed. For example, a polymer ball may be included in the adhesive layer, and an organic solvent may be contained in the ball. When the adhesive layer is heated, the organic solvent may boil above a certain temperature and the internal pressure of the ball may increase. As the internal pressure increases, the membrane of the polymer ball may expand. If the expanded balls break through the insulation layer at the same time, the adhesive layer can be removed along with the insulation layer in this area.

As the adhesive layer is removed, the first connection electrode 400 and the second connection electrode 500 may be exposed, and the first insulation layer 910 may also be exposed.

Referring to FIG. 27I, the first external electrode 700 that is connected to the first connection electrode 400 of the individual laminate 100a may be formed, and the second external electrode 800 that is connected to the second connection electrode 500 may be formed.

Except for the above, a redundant description of a part having the same features as a coil electronic component according to the above-described embodiment will be omitted.

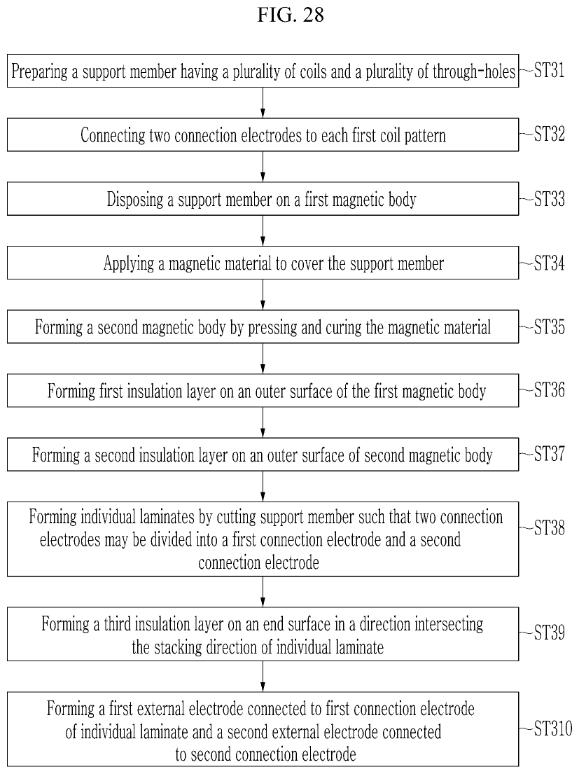

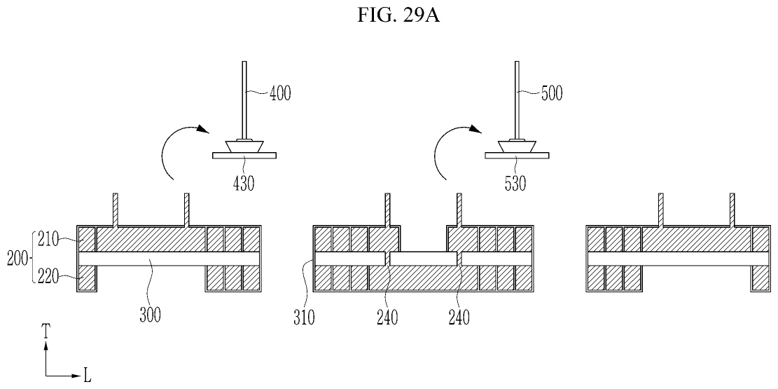

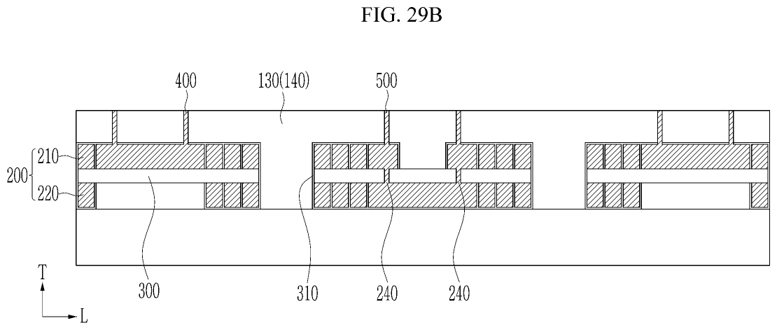

FIG. 28 is a flowchart showing a manufacturing method of a coil electronic component according to still another embodiment. FIG. 29A and FIG. 29B are drawings for explaining a manufacturing method of a coil electronic component.

Referring to FIG. 28, a manufacturing method of a coil electronic component according to an embodiment may include a step ST31 of preparing a support member having a plurality of coils and a plurality of through-holes; a step ST32 of connecting two connection electrodes to each first coil pattern; a step ST33 of disposing the support member on a first magnetic body; a step ST34 of applying a magnetic material to cover the support member; a step ST35 of forming a second magnetic body by pressing and curing the magnetic material; a step ST36 of forming a first insulation layer on an outer surface of the first magnetic body; a step ST37 of forming a second insulation layer on an outer surface of the second magnetic body; a step ST38 of forming individual laminates by dicing the support member such that the two connection electrodes may be divided into a first connection electrode and a second connection electrode; a step ST39 of forming a third insulation layer on a diced surface of the individual laminate, i.e., an end surface in a direction along which the support member is diced to form the individual laminate; and a step ST310 of forming a first external electrode connected to the first connection electrode of the individual laminate and a second external electrode connected to the second connection electrode of the individual laminate.

At the step ST34, the magnetic material may be applied such that a free end of the connection electrode may be exposed.

Referring to FIG. 29A, the connection electrodes 400 and 500 may be connected to the first coil pattern 210. The connection electrodes 400 and 500 may be a vertical bonding wire. In this case, after forming a plurality of pads 430 and 530 on a surface of the first coil pattern 210, the connection electrodes 400 and 500 may be connected to each of the pads 430 and 530. That is, the first connection electrode 400 may be connected to the first lead-out portion 213 of the first coil pattern 210 by ball bonding. The connection method by ball bonding may be the same as known in the art. For example, ball bonding may be performed by melting one end of the bonding wire to form a ball (i.e., free air ball) and pressing this ball to the first lead-out portion 213. However, the opposite end of the bonding wire may remain as a free end, not connected to the first coil pattern. Before performing ball bonding, the process of removing the insulation layer IF (see FIG. 2) may be performed by radiating a laser beam to the first lead-out portion 213 of the first coil pattern 210. The second connection electrode 500 may also be ball-bonded in a similar manner.

Referring to FIG. 29B, after disposing the support member 300 on the first magnetic body 120, the magnetic material 130 may be applied to cover the support member 300. Here, the magnetic material 130 may be applied such that the free ends of the connection electrodes 400 and 500 may be exposed. For example, the exposed surface of the free ends of the connection electrodes 400 and 500 may form a flush surface with the surface of the second magnetic body 140.

Steps except for the above may be performed in the same method as the embodiment of FIG. 21, or may be performed in the same method as the embodiment of FIG. 26. Accordingly, a redundant description of a part having the same features as a manufacturing method of a coil electronic component according to the above-described embodiment will be omitted.

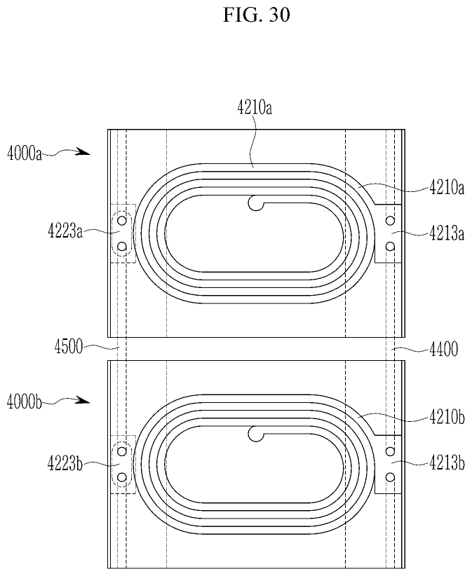

FIG. 30 is a drawing schematically showing two coil electronic components according to an embodiment in a state of being connected in parallel.

Referring to FIG. 30, a first coil electronic component 4000a and a second coil electronic component 4000b may be connected in parallel through a first connection conductor 4400 and a second connection conductor 4500.

The first coil electronic component 4000a and the second coil electronic component 4000b are the same as the coil electronic component shown in FIG. 9, and a redundant detailed description thereof will be omitted. In order to clearly represent the relationship between the components, the second coil patterns of the first coil electronic component 4000a and the second coil electronic component 4000b are not shown in FIG. 30.

A first lead-out portion 4213a of a first coil pattern 4210a of the first coil electronic component 4000a and a first lead-out portion 4213b of a first coil pattern 4210b of the second coil electronic component 4000b may be connected through the first connection conductor 4400. In addition, a second lead-out portion 4223a of a second coil pattern (not shown) of the first coil electronic component 4000a and a second lead-out portion 4223b of a second coil pattern (not shown) of the second coil electronic component 4000b may be connected through the second connection conductor 4500.

The first connection conductor 4400 and the second connection conductor 4500 may be a ball bonding wire or a wedge bonding wire.

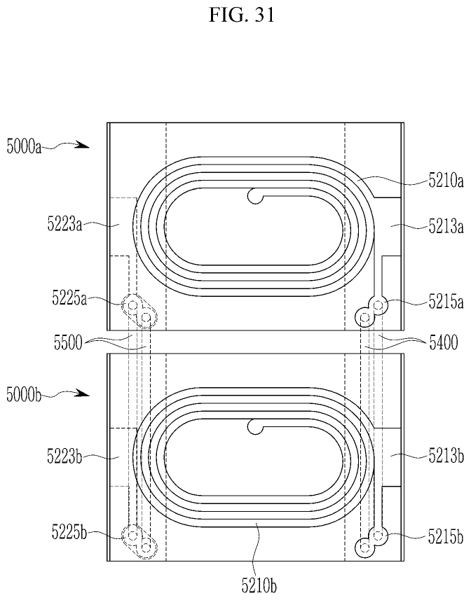

FIG. 31 is a drawing schematically showing two coil electronic components according to another embodiment in a state of being connected in parallel.

Referring to FIG. 31, a first coil electronic component 5000a and a second coil electronic component 5000b may be connected in parallel through a first connection conductor 5400 and a second connection conductor 5500.

The first coil electronic component 5000a and the second coil electronic component 5000b are the same as the coil electronic component shown in FIG. 10, and a redundant description thereof will be omitted. In order to clearly represent the relationship between the components, the second coil patterns of the first coil electronic component 5000a and the second coil electronic component 5000b are not shown in FIG. 31.

A first extension portion 5215a of a first coil pattern 5210a of the first coil electronic component 5000a and a first extension portion 5215b of a first coil pattern 5210b of the second coil electronic component 5000b may be connected through two first connection conductors 5400. In addition, a second extension portion 5225a of a second coil pattern (not shown) of the first coil electronic component 5000a and a second extension portion 5225b of a second coil pattern (not shown) of the second coil electronic component 5000b may be connected through two second connection conductors 5500 and 5500.

The first connection conductor 5400 and the second connection conductor 5500 may be a ball bonding wire or a wedge bonding wire.

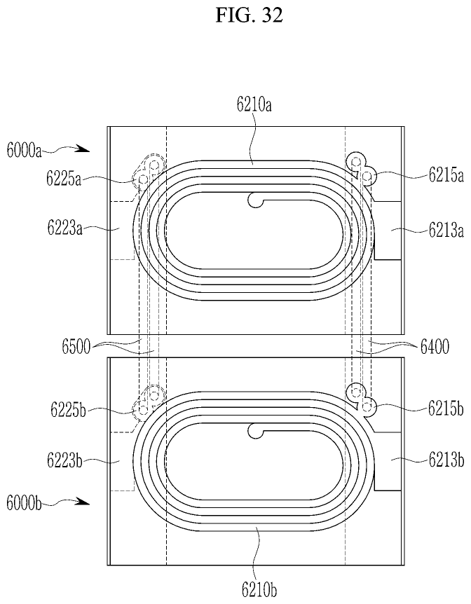

FIG. 32 is a drawing schematically showing two coil electronic components according to still another embodiment in a state of being connected in parallel.

Referring to FIG. 32, a first coil electronic component 6000a and a second coil electronic component 6000b may be connected in parallel through a first connection conductor 6400 and a second connection conductor 6500.

The first coil electronic component 6000a and the second coil electronic component 6000b are the same as the coil electronic component shown in FIG. 12, and a redundant detailed description thereof will be omitted. In order to clearly represent the relationship between the components, the second coil patterns of the first coil electronic component 6000a and the second coil electronic component 6000b are not shown in FIG. 32.

A first extension portion 6215a of a first coil pattern 6210a of the first coil electronic component 6000a and a first extension portion 6215b of a first coil pattern 6210b of the second coil electronic component 6000b may be connected through two first connection conductors 6400 and 6400. In addition, a second extension portion 6225a of a second coil pattern (not shown) of the first coil electronic component 6000a and a second extension portion 6225b of a second coil pattern (not shown) of the second coil electronic component 6000b may be connected through two second connection conductors 6500 and 6500.

The first connection conductor 6400 and the second connection conductor 6500 may be a ball bonding wire or a wedge bonding wire.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

1000, 2000, 3000: coil electronic component
100: magnetic body
200: coil
210: first coil pattern
220: second coil pattern
230: first via
240: second via
213: first lead-out portion
223: second lead-out portion
250: connection portion
300: support member
400: first connection electrode
500: second connection electrode
700: first external electrode
800: second external electrode
900: insulation layer
1100: the adhesive layer
IF: insulation layer

What is claimed is:

1. A coil electronic component, comprising:
a magnetic body having a first surface and a second surface opposing each other in a first direction, a third surface and a fourth surface opposing each other in a second direction intersecting the first direction, and a fifth surface and a sixth surface opposing each other in a third direction intersecting both the first and second directions and comprising a magnetic material;
a coil embedded in the magnetic body;
an external electrode disposed on the sixth surface of the magnetic body; and
a connection electrode disposed within the magnetic body and connecting the coil and the external electrode, and comprising an extension portion having a diameter greater than a diameter of a remaining portion of the connection electrode.

2. The coil electronic component of claim 1, further comprising:
a support member embedded in the magnetic body and comprising a first support surface and a second support surface opposing each other in the third direction,
wherein the coil comprises a first coil pattern disposed on the first support surface of the support member, a second coil pattern disposed on the second support surface of the support member, and a via connecting the first coil pattern and the second coil pattern.

3. The coil electronic component of claim 1, wherein the extension portion is disposed at an end portion of the connection electrode that is connected to the coil.

4. The coil electronic component of claim 1, wherein the connection electrode comprises a first portion extending in the third direction and connected to the coil and a second portion extending in the first direction and connected to the external electrode.

5. The coil electronic component of claim 1, wherein the connection electrode comprises a first portion extending in the third direction and connected to the coil and a second portion extending in the second direction and connected to the external electrode.

6. The coil electronic component of claim 1, wherein:
the connection electrode is formed of a different material from the coil; and
an intermetallic compound is disposed at an interface between the connection electrode and the coil.

7. The coil electronic component of claim 6, wherein:
the coil comprises copper (Cu); and
the connection electrode comprises gold (Au), aluminum (Al), silver (Ag), or an alloy thereof.

8. The coil electronic component of claim 1, wherein a portion where the connection electrode is connected to the external electrode and a portion where the connection electrode is connected to the coil are on a center line in the first direction when viewed from the third direction.

9. The coil electronic component of claim 1, wherein a portion where the connection electrode is connected to the external electrode and a portion where the connection electrode is connected to the coil are biased toward the second direction with respect to a center line in the first direction when viewed from the third direction.

10. The coil electronic component of claim 2, wherein:
the external electrode comprises a first external electrode and a second external electrode;
the connection electrode comprises a first connection electrode connecting the first coil pattern and the first external electrode and a second connection electrode connecting the second coil pattern and the second external electrode; and
the first connection electrode and the second connection electrode are disposed to be biased toward the third surface or the fourth surface of the magnetic body.

11. The coil electronic component of claim 2, wherein:
the external electrode comprises a first external electrode and a second external electrode;
the connection electrode comprises a first connection electrode connecting the first coil pattern and the first external electrode and a second connection electrode connecting the second coil pattern and the second external electrode; and
one connection electrode among the first connection electrode and the second connection electrode is disposed to be biased toward the third surface of the magnetic body, and other connection electrode is disposed to be biased toward the fourth surface.

12. A method of manufacturing a coil electronic component, the method comprising:
preparing a plurality of coils;
connecting pairs of adjacent coils of the plurality of coils to each other by connection conductors;
disposing the plurality of coils on a first magnetic body;
applying a magnetic material to cover the plurality of coils;
forming a second magnetic body by pressing and curing the magnetic material;
forming an individual laminate by dicing the first magnetic body and the second magnetic body such that each connection conductor may be divided into a first connection electrode and a second connection electrode; and
forming a first external electrode that is connected to the first connection electrode of the individual laminate and a second external electrode that is connected to the second connection electrode of the individual laminate.

13. The method of claim 12, wherein,
the step of preparing a plurality of coils, comprises:
preparing a support member having the plurality of coils, each surrounding a corresponding through-hole, wherein each coil comprises a first coil pattern disposed on a first surface of the support member, and a second coil pattern disposed on a second surface of the support member opposing the first surface, the second coil pattern being connected to the first coil pattern by a via penetrating the support member;
the step of connecting pairs of adjacent coils of the plurality of coils, comprises:
connecting pairs of adjacent first coil patterns of the plurality of coils to each other by the connection conductors;
the step of disposing the plurality of coils on a first magnetic body, comprises:
disposing the support member on the first magnetic body;
the step of applying a magnetic material to cover the plurality of coils, comprises:
applying the magnetic material to cover the support member; and
the step of forming an individual laminate comprises:
dicing the support member.

14. The method of claim 12, wherein, in the step of applying the magnetic material, a portion of the connection conductors is exposed.

15. The method of claim 13, further comprising, before the step of forming the individual laminate:
forming a first insulation layer on an outer surface of the first magnetic body; and
forming a second insulation layer on an outer surface of the second magnetic body.

16. The method of claim 15, wherein, in the step of applying the magnetic material, a portion of the connection conductors is exposed, and
wherein in the step of forming the second insulation layer on an outer surface of the second magnetic body, the second insulation layer is formed to be spaced apart from the exposed portion of the connection conductors.

17. The method of claim 16, comprising, before the step of forming the first external electrode and the second external electrode:
forming a third insulation layer on an end surface of the individual laminate in a direction along which the support member is diced.

18. The method of claim 14, comprising, before the step of forming the individual laminate:
forming a second insulation layer on an outer surface of the second magnetic body; and
forming an adhesive layer to cover the second insulation layer and an outer surface of the second magnetic body.

19. The method of claim 18, comprising, before the step of forming the first external electrode and the second external electrode:
forming a fourth insulation layer to cover the adhesive layer and an outer surface of the individual laminate; and
removing the adhesive layer.

20. A method of manufacturing a coil electronic component, the method comprising:
preparing a plurality of coils;
connecting two connection electrodes to each of the plurality of coils;
disposing the plurality of coils on a first magnetic body;
applying a magnetic material to cover the plurality of coils;
forming a second magnetic body by pressing and curing the magnetic material;
forming an individual laminate by dicing the first magnetic body and the second magnetic body; and
forming an external electrode that is connected to a connection electrode of the individual laminate.

21. The method of claim 20, wherein:
the step of preparing a plurality of coils, comprises:
preparing a support member having the plurality of coils, each surrounding a corresponding through-hole and comprising a first coil pattern disposed on a first surface of the support member with respect to the through-hole, and a second coil pattern disposed on a second surface of the support member and connected to the first coil pattern by a via penetrating the support member, the first and second surfaces opposing each other;
the step of connecting two connection electrodes, comprises:
connecting two connection electrodes to each first coil pattern;
the step of disposing the plurality of coils on a first magnetic body, comprises:
disposing the support member on the first magnetic body;
the step of applying a magnetic material to cover the plurality of coils, comprises:
applying the magnetic material to cover the support member; and
the step of forming an individual laminate, comprises:
dicing the support member.

22. A coil electronic component, comprising:
a magnetic body encapsulating a coil;
an external electrode disposed on an external surface of the magnetic body; and
a connection electrode disposed in the magnetic body and connecting the coil to the external electrode, the connection electrode comprising a wire,
wherein a cross-section of the wire at a first end of the wire contacts the coil, and one or both of a cross-section and a surface area of the wire at a second end of the wire contacts the external electrode.

23. The coil electronic component of claim 22, further comprising:
a support member having a through-hole penetrating therethrough, and wherein
the coil comprises: a first coil pattern disposed on a first surface of the support member and around the through-hole, and a second coil pattern disposed on a second surface of the support member opposing the first surface in a direction and around the through-hole,
the magnetic body encapsulates the support member and the first and second coil patterns, a portion of the magnetic body filling the through-hole to form a core of the first and second coil patterns,
the external electrode comprises: first and second external electrodes disposed on an external surface of the magnetic body and spaced apart from each other,
the connection electrode comprises: first and second connection electrode disposed in the magnetic body and respectively connecting the first and second coil patterns to the first and second external electrodes, each of the first and second connection electrodes comprising a wire, and
a cross-section of the wire at a first end of the wire contacts a corresponding coil pattern, and one or both of a cross-section and a surface area of the wire at a second end of the wire contacts a corresponding external electrode.

24. The coil electronic component of claim 23, wherein one or both of the first and second coil patterns include a lead-out portion, to which the first end of the wire is connected.

25. The coil electronic component of claim 23, wherein one or both of the first and second connection electrodes comprises a plurality of wires, each connected to the corresponding coil pattern and the corresponding external electrode.

26. The coil electronic component of claim 23, further comprising an insulation layer disposed on an external surface of the magnetic body except at a portion where the first and second external electrodes are disposed.

27. The coil electronic component of claim 23, wherein a material of the wire is different from a material of the first and second coil patterns.

28. The coil electronic component of claim 23, wherein a contact between the wire and the corresponding connection electrode comprises an intermetallic compound.

29. The coil electronic component of claim 23, wherein when viewed in the direction along which the first and second surfaces of the support member oppose each other, the second end of the wire of one or both the first and second connection electrodes does not overlap with the corresponding coil pattern.

30. The coil electronic component of claim 23, wherein a surface each of the first and second coil patterns is covered by an insulating film except for a portion where the wire contacts the corresponding coil pattern.

31. The coil electronic component of claim 30, wherein the portion where the wire contacts the corresponding coil pattern has an area larger than a cross-section area of the wire.
